(19) United States
(12) Patent Application Publication
(10) Pub. No.: US 2023/0141518 A1
(43) Pub. Date: May 11, 2023

(54) HIGH SPEED NUT CRACKING APPARATUS

(71) Applicant: Savage Equipment Incorporated, Madill 73446, OK (US)

(72) Inventors: Basil W. Savage, Madill, OK (US); Steven W. Savage, Madill, OK (US); Willliam Ferrell Wagoner, Madill, OK (US)

(21) Appl. No.: 18/010,138

(22) PCT Filed: Jun. 17, 2021
(86) PCT No.: PCT/US2021/037872

§ 371 Date: Dec. 13, 2022

Related U.S. Application Data
(60) Provisional application No. 63/040,349, filed on Jun. 17, 2020.

(51) Int. Cl. A23N 5/00

(52) U.S. Cl. CPC A23N 5/00

(57) ABSTRACT

A nut cracking apparatus has a frame with a rotatable turret mounted thereto. A plurality of nut cracking units in the rotatable turret comprise pistons movable from a retracted position to an extended position and crack dies aligned with the piston. Air is communicated through feed air passages in the rotatable turret to urge the pistons from a retracted to an extended position.

### CROSS-REFERENCE TO RELATED APPLICATIONS

This application claims the benefit of PCT Application No. PCT/US2021/037872 filed on Jun. 17, 2021, which claims the benefit of U.S. Provisional Application No. 63/040,349 filed on Jun. 17, 2020, both applications of which are hereby incorporated by reference.

### BACKGROUND

Nut cracking apparatus for cracking nuts generally include an endless conveyor that delivers nuts to a rotating turret. Nuts are cracked by providing a motive force for a shuttle to impact a crack die in which a nut is held. The current disclosure is directed to a high speed compact nut cracking apparatus.

### BRIEF DESCRIPTION OF THE DRAWINGS

FIG. 1 is a rear end view of the nut cracking apparatus.

FIG. 2 is a perspective view showing the front and right sides of the nut cracking apparatus.

FIG. 3 is a view from line 3-3 of FIG. 1.

FIG. 4 is a view from line 4-4 of FIG. 1.

FIG. 5 is a view showing the turret and motor with the door and an outer panel removed.

FIG. 6 is a partially exploded view of the rotatable turret of the nut cracking apparatus.

FIGS. 7-10 show an exploded view of the rotated turret.

FIG. 11 is a view of the rotatable turret mounted in the frame of the nut cracking apparatus.

FIGS. 12-17 show the direction of the section views for FIGS. 18-23.

FIG. 18 is a section view from line 18-18 of FIG. 12.

FIG. 19 is a section view from line 19-19 of FIG. 13.

FIG. 20 is a section from line 20-20 of FIG. 14.

FIG. 21 is a line from section 21-21 of FIG. 15.

FIG. 22 is a section from line 22-22 of FIG. 16.

FIG. 23 is a section from line 23-23 of FIG. 17.

FIG. 24 is a view of the exit end of a shuttle cylinder housing.

FIG. 25 is a view of the entry end of the shuttle cylinder housing.

FIG. 26 is a perspective view of a shuttle cylinder housing.

FIG. 27 is a view of the exit end of the center hub.

FIG. 28 is a view of the entry end of the center hub.

FIG. 29 is a view of the exit end of a cylinder seal plate.

FIG. 30 is a view of the entry end of the cylinder seal plate.

FIG. 31 is a view of the exit end of a cylinder head plate.

FIG. 32 is a view of the entry end of the cylinder head plate.

FIG. 33 is perspective view showing the exit end of a cylinder front plate.

FIG. 34 is a view showing the entry end of the cylinder front plate.

FIG. 35 is a view of the exit end of a piston cylinder body.

FIG. 36 is a view of the entry end of the piston cylinder body.

FIG. 37 is a perspective view of a cylinder end plate segment.

FIG. 38 is a view looking at the side of a cylinder end plate segment.

FIG. 39 is a side view of a cylinder end plate segment.

FIG. 40 is a view of the exit end of the exit face of a valve.

FIG. 41 is a view of the entry end of the valve.

FIG. 42 is a perspective view of the valve.

FIG. 43 is a view of the interior of a valve cover plate.

FIG. 44 is a view of the exit end of a valve adapter plate.

FIG. 45 is a view of the entry end of the valve adapter plate.

FIG. 47 is a perspective view of the valve adapter plate.

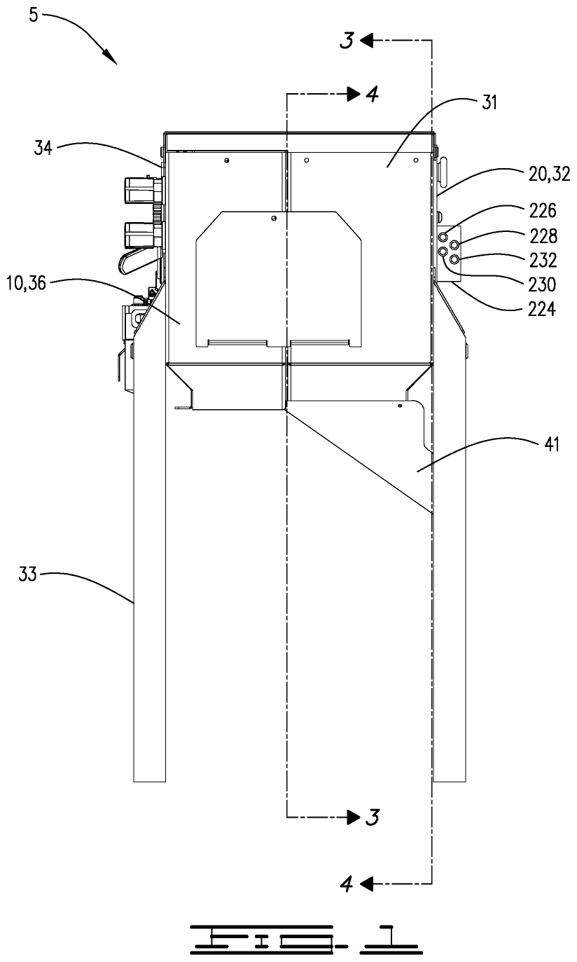

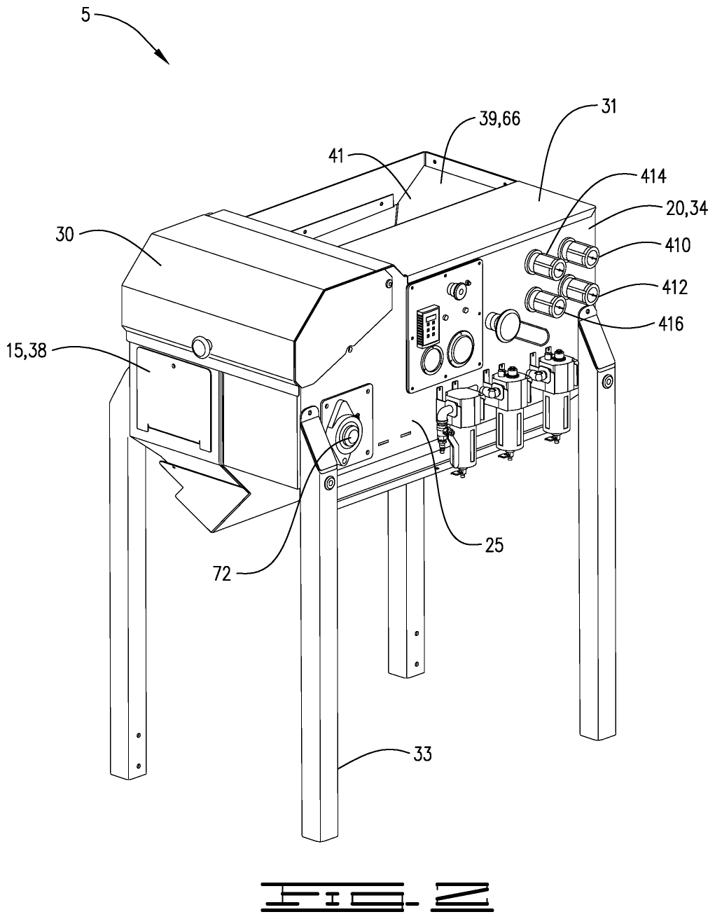

FIG. 46 is a side view of the valve adapter plate.

FIG. 48 is a view of the entry end of the valve plate with the valve positioned adjacent thereto.

FIG. 49 is a cross section of an alternate embodiment of a piston.

### DESCRIPTION OF AN EMBODIMENT

A high speed nut cracking apparatus 5 has a rear end 10, a forward end 15, a left or first side 20 and a second or right side 25. A door 30 is pivotally connected by a hinge or otherwise to the frame and is movable between open and closed positions. Thee nut cracking apparatus is an internally ported nut cracker 5, in that there are no external hoses or other external means used to provide air to the moving parts of the apparatus. As is explained in more detail below, the nut cracking apparatus 5 has a movable piston and a shuttle that interact to crack nuts. The air that moves the piston and the shuttle is provided directly through passageways defined through a rotating turret. The passageways that deliver air to the cylinders in which the pistons and the shuttles are positioned are completely contained within the rotating turret. The nut cracking apparatus 5 can crack nuts at a high speed which may vary, depending on the size of the particular nut being cracked. The nut cracking apparatus 5 may exceed a rate of at least 750 nuts/minute, and in some cases much higher, for example 950 nuts/minute. Nut cracking apparatus 5 may for example have an overall size of, for example about 27.2 inches wide, 21.7 inches high and 40.2 inches long, when the apparatus 5 is in position over a conveyor without legs attached. Known nut crackers capable of cracking nuts at such speeds are much larger. The apparatus 5 of the current disclosure eliminates parts, for example air hoses, and a piston rod extension, which allows a sizable reduction in the width and length of high speed nut cracking apparatus. The elimination of the air hoses is possible as a result of providing the air passageways through the turret to move the pistons and shuttles within the turret.

In addition to having a much smaller footprint than known crackers, the nut cracking apparatus 5 provides for the removal and replacement of internal parts with little disassembly, and with the ability to make certain that replacement of parts is accurate and easy. Nut cracking apparatus 5 includes a frame 31 with a left side 32, right side 34, rear 36 and forward side 38. Frame 31 in the embodiment shown is positioned on legs 33. The height of apparatus 5 with legs 33 attached is about 50.7 inches. Nut cracking apparatus 5 includes a top 39 and a bottom 40. Top 39 has an open portion through which nuts to be cracked are delivered. Cracked nuts may pass through the bottom of the frame 31 to a conveyor or other apparatus, and may be delivered to the conveyor or other apparatus with a chute 41 that receives the cracked nuts.

A turret 43 is rotatably mounted in frame 31. Rotatable turret 43 includes a plurality of nut cracking units 42. Nut cracking units 42 are utilized to hold and crack nuts as turret 43 rotates. Nut cracking units 42 have longitudinal central axis 44. A motor 46 which may be a variable speed drive motor is mounted to frame 31 with brackets 48 or other means known in the art.

A drive sprocket 50 is rotated by motor 46. A drive chain 52 engages drive sprocket 50. Nut cracking apparatus 5 includes a first follower sprocket 54 and a second follower sprocket 56. First and second follower sprockets 54 and 56 rotate about bearings mounted to brackets attached to frame 31 in a manner known in the art. A turret sprocket 58 is connected to turret 43 and will rotate turret 43 about a shaft 97. An endless conveyor drive sprocket 60 is connected to a shaft 70 and will rotate therewith. Endless conveyer 62 is driven by conveyor drive sprocket 60.

A center divider 64 is mounted to the frame and separates the frame into a hopper portion 66 which has an open top 67 into which nuts are provided and a drive portion 68 which includes the majority of the working and moving parts.

Shaft 70 is rotatably mounted in first bearing 72 that is connected to frame 31 on the right side thereof. Shaft 70 extends through drive portion 68 and is rotatably mounted in a second bearing 74 that is mounted to center divider 64. Shaft 70 extends therethrough into the hopper portion 66. Endless conveyor 62 is supported by and slides over a slide 63 connected in frame 31. Endless conveyor 62 is mounted on a forward chain sprocket 76 and a rear chain sprocket 78. Forward chain sprocket 76 is fixed to shaft 70 and rotates therewith. The rotation of forward sprocket 76 moves the chain from the rear to the forward end of the nut cracking apparatus 5. Endless conveyor 62 comprises a nut chain 80 fixed to a roller chain 82. Roller chain 82 engages forward chain sprocket 76. Nut chain 80 defines a plurality of nut pockets 84. Nuts delivered into hopper 66 will be received in nut chain pocket 84 and delivered to a pick up point 86 at which the nut cracking units 42 will engage a nut carried in one of the nut pockets 84. In one embodiment pickup point 86 is just before a nut cracking unit 42 reaches bottom dead center, for example between 1 and 10 degrees, and in one embodiment between 2 and 5 degrees and in one embodiment about 3 degrees prior to bottom dead center. The foregoing values are exemplary only and not limiting. Nuts delivered into hopper 66 will fall downward on chute 41. Nuts will gather on a floor 90 which may be a vibrating floor 90. The vibration of floor 90 will encourage nuts to pass into nut pockets 84. Slide 63 may have a curved upper surface. The curved upper surface of slide 63 will create a curvature in the endless conveyor 62 and may aid in allowing nuts to properly seat in nut pockets 84. A vibrator 92 of a type known in the art may be utilized to vibrate floor 90. A plurality of deflectors 94 are attached to center divider 64 to remove nuts that may be carried improperly and to ensure only one nut is carried in a nut pocket. Nuts are delivered into open upper end 67 into hopper 66. FIGS. 43 and 46 show a vibrator mount plate 91 to which vibrator 92 is mounted. Pan to vibrator mounts 93 translate the vibration of the vibrator 92 to the floor 90. The view shows a slot 95 which allows the mount plate 91 to reciprocate in the rear to forward direction.

Rotatable turret 43 is mounted on shaft 97 that is fixed at both ends to frame 31. Turret 43 will rotate about shaft 97 on bearings 98 and 99. Spacers 101 and 103 may be positioned on shaft 97 as needed. Rotatable turret 43 includes a valve plate 100 which is a rotatable valve plate 100. Rotatable valve plate 100 is positioned in a valve plate housing 102. A valve seal 104 is positioned in valve plate housing 102 between an end plate 106 of valve plate housing 102 and valve plate 100. A valve gasket 108 is positioned between valve plate 100 and a shuttle cylinder housing 110. Valve plate 100 is mounted to shuttle cylinder housing 110 with a plurality of fasteners 112 extending through openings 114 in valve plate 100 and threaded into corresponding openings in shuttle cylinder 110. Shuttle cylinder housing 110 has a plurality of shuttle cylinders 116 extending therethrough. Shuttle cylinder housing 110 has an air entry end 115 and an air exit end 117. A plurality of shuttles 118 are received in shuttle cylinder housing 110, and more specifically a single shuttle 118 is received in each of shuttle cylinders 116. Shuttles 118 may comprise generally cylindrical shuttles. A shuttle return seal 120 is positioned at a first, or rear end 122 of each shuttle cylinder 116 and will be positioned between valve plate 100 and shuttle 118. Shuttle cylinders 116 have forward end 124, and when air is applied at rear end 122, shuttle 118 will move toward a crack die 130 to impact crack die 130 and crack a nut that is engaged therewith. Air is applied through entry end 115 directly to the rear end of shuttle cylinder 116 to move the shuttle 118 toward the forward end 124 and into crack die 130. Shuttle cylinder 116 has an air passageway from the entry end 115 to the exit end 117. Air is provided therethrough to move the shuttle 118 from the forward end 124 to the rear end 122 of shuttle cylinder 116 to reset the shuttle to move once again toward the crack die 130.

A plurality of crack dies 130 are positioned in a crack die holder 132. Crack dies 130 have impact face 129 and a nut holding face 131. Nut holding face 131 may comprise a generally V-shaped nut holding face for engaging and holding a nut to be cracked. Crack dies 130 can be removed and replaced so that different sizes of nuts can be easily accommodated and cracked with nut cracking apparatus 5. Crack dies 130 may be held in place in a crack die holder 132 with crack die seals 134. Crack die holder 132 is mounted to an end of shuttle cylinder housing 110 with a plurality of fasteners 136 extending through openings 138 and threaded into openings in shuttle cylinder housing 110. Thus, the only disassembly required to replace crack dies 130 is the removal of fasteners 136, which are accessible without removal of any other parts, and replacing the crack dies 130 with those having the desired nut holding face 131 for the size of nut to be cracked.

A plurality of fasteners 140 may extend through a central opening 142 in crack die holder 132 and used to connect other parts of turret 43 as explained below. Fasteners 140 extend through openings 144 in shuttle cylinder housing 110 and are threaded into corresponding holes in center hub 150.

Center hub 150 comprises a radially outwardly extending plate 146 in a central portion thereof. Center hub plate 146 has bushing openings 148 therethrough to receive a plurality of guide bushings 147. Fasteners 145 may be used to hold guide bushings 147 in place. A gasket 152 may be positioned between center hub 150 and shuttle cylinder housing 110. Center hub 150 has an air entry end 149 and an air exit end 151.

Starting now at the right side of nut cracking apparatus 5 turret sprocket 58 is mounted to a cylinder end plate 154. Cylinder end plate 154 is a sectioned end plate, and may comprise first and second portions 155 and 156. Because cylinder end plate 154 is a sectioned end plate, the removal and replacement of selected parts without major disassembly is possible. Cylinder end plate 154 is mounted to a piston cylinder body 160 and may have a gasket 161 therebetween. Piston cylinder body 160 has an exit end 162 for exiting air, and an entry end 163 for entering air. Fasteners 166 connect turret sprocket 58 to cylinder end plate 154. Fasteners 168 connect cylinder end plate 154 to cylinder body 160. A cylinder body gasket 170 is positioned between cylinder body 160 and a cylinder front plate 172. A cylinder head gasket 174 is positioned between cylinder front plate 172 and a cylinder head plate 176. A second cylinder head gasket 180 is positioned between cylinder head plate 176 and cylinder seal plate 182.

A plurality of fasteners 184 extend through cylinder seal plate 182, cylinder head gasket 180 and cylinder head plate 176 and are threaded into cylinder body 160. A plurality of fasteners 192 extend through a central opening 153 of cylinder end plate 154, through openings in cylinder body 160, cylinder body gasket 170, cylinder front plate 172, first cylinder head gasket 174, cylinder head plate 176, second cylinder head gasket 180, cylinder seal plate 182 and threaded into openings in center hub 150. Cylinder head plate 176 has air entry end 186 and air exit end 188.

A plurality of pistons 200 extend through piston cylinders 202 defined in piston cylinder body 160. Piston 200 comprises a piston head 204. Piston cylinders 202 have a rear end 201 and a forward end 203. Piston head 204 may have grooves in which cup seals 206 are placed and may have a wear strip 208 in a groove therebetween. A piston rod 210 extends from piston head 204. Piston rod 210 has an opening 211 extending for a portion of the length thereof, and is thus hollow for a portion thereof. Nut clamping end 212 may be a V-shaped end 214 which is configured to secure a nut for cracking as will be described in detail herein. Pistons 200 reciprocate between a retracted position 215 and an extended position 216 in which the piston rod extends through guide bushing 147 to secure a nut with crack die 130. Wiper seals 217 and wear bushings 218 may be used to slidingly and sealingly secure piston rod 210 in cylinder head plate 176. In order to remove and replace pistons 200, the only disassembly required is to loosen chain 52, remove sprocket 58 and one, or both of sections 155 and 156 of cylinder end plate 154. No removal of hoses or other parts is needed which makes removal and replacement of pistons 200 a simple operation allowing for replacement of worn pistons, or a change to a piston 200 for cracking different sized nuts.

In an additional embodiment the piston may comprise a piston 500 with a piston head 502 and a piston rod 504 extending therefrom having a nut clamping end 506. Piston rod 504 does not have a hollow portion as described with respect to piston rod 210, and it is understood that the piston rod in either case may be solid, or have a hollow portion, so that the weight of the piston rods can be modified as desired. Nut clamping end 506 may be shaped like nut clamping end 212 of piston 200. Pistons 500 will move within piston cylinders 202 as previously described with respect to pistons 200. Piston head 502 has a generally cylindrical center portion 508 with a wear strip 509 which may be for example a DELRIN® ring. Piston head 502 has a rear portion 510 that slopes radially inwardly in a rear direction from center portion 508 and has a forward portion 512 that slopes radially inwardly in the forward direction. Thus, in cross section as shown in FIG. 49, the piston head 502 generally has the shape of seven sides of an octagon.

In the additional embodiment described, piston cylinders 202 have bumper seals 514 comprising a rear bumper seal 516 and a forward bumper seal 518 which are engaged by piston head 502 in the retracted and extended positions of the piston 500. Rear bumper seal 516 has an engagement profile 517 which is a generally frustoconical engagement profile 517. Likewise, forward seal 518 has a frustoconical engagement profile 519. Rear portion 510 of piston head 502 has mating profile 511 to engage the frustoconical profile on rear seal 516. Forward portion 512 likewise has an engagement profile 513 that mates with the frustoconical engagement profile 519 on forward seal 518. The operation of the cracker described herein is identical whether using pistons 200 or pistons 500.

Returning now to the left side rotating valve plate 100 is received in valve housing 102. A valve 220 is mounted to a valve adapter plate 222 which is in turn connected to a valve cover plate 224. Valve adapter plate 222 has an air entry side 223 and an air exit side 225. Valve cover plate 224 has fittings on a side thereof to receive air hoses to provide feed, release, reset and crack air. The openings are identified as a feed opening 226, a release opening 228, a reset opening 230 and a crack opening 232. Air is provided to each opening such that nut cracking units 42 will engage and hold a nut. As the turret 43 rotates, feed air will urge a piston 200 into the extended position 216 to hold a nut against a crack die 130. Crack air will urge the shuttle 118 in the shuttle cylinder to impact crack die 130 and crack the nut held between a piston 200 and a crack die 130. Release air is applied to move the piston 200 to the retracted position 215. Reset air is applied to move the shuttle to the rear end 122 of the shuttle cylinder 116. Crack air is applied a second time to cause a second impact to crack die 130 to remove any fragments from crack die 130. Reset air is then reapplied to move the shuttle 118 to the rear end 122 of shuttle cylinder 116, and the nut cracking unit 42 is ready to repeat the process. Although a particular sequence of the cracking process is described herein, it is understood that other sequences are possible and that described herein is not limiting. The passageways from the valve 220 to the piston 200 that move the piston between the retracted and extended positions 215 and 216 are through the turret 43. No hoses are needed to provide air to any piston cylinders as is the manner of use in prior art crackers. Thus, each of the components from the valve 220 to the cylinder body 160 and ultimately to the cylinder end plate 154 have ports and passages that communicate air all the way through the turret 43 to move the piston rod 200 between the feed, or extended position 216 and the release, or retracted position 215.

Valve cover plate 224 is internally ported so that the feed, release, reset and crack openings 226, 228, 230 and 232 respectively are communicated to feed, release, reset and crack openings in valve adapter plate 222. Openings in valve cover plate 224 include first and second reset openings 240 and 242 a feed opening or feed slot 244, a release opening or a release slot 246 and a crack opening 248 which is a curved cracked slot opening 248. An exhaust opening 243 is defined in valve cover plate 224. Valve adapter plate 222 is connected to valve housing plate 224 with fasteners through opening 226. Air will pass into and through valve adapter plate 222 from valve housing plate 224. Valve adapter plate 222 has a plurality of cylindrical extensions extending therefrom. Cylindrical extensions 250, which may be referred to as bushings 250, include a feed air extension 252, a release air extension 254, a first crack extension 256, a second crack extension 258, a first reset extension 260 and a second reset extension 262. Extension 252 defines a feed opening 264. Release, first crack, second crack, first reset, and second reset cylindrical extensions 256, 258, 260 and 262 define release opening 266, first crack opening 268, second crack opening 270, first reset opening 272 and second reset opening 274 respectively. A relief port 275 is defined in valve adapter plate 222.

Air entry face 223 of the valve adapter plate 222 has a crack slot 280 that aligns with crack slot 248 in valve housing plate 224. Crack slot 280 has first and second crack openings 268 and 270 at opposed ends thereof. A feed slot 282 aligns with feed slot 244 in valve housing plate 224 and has feed opening 264 at an end thereof. A release slot 284 aligns with release slot 246 in valve housing plate 224 and has opening 266 at an end thereof. Appropriate shaped seals 286 may be utilized to seal valve adapter plate 222, to valve housing plate 224 when connected.

Valve 220 has plurality of openings 288 to receive the cylindrical extensions 250. Valve 220 is placed onto cylindrical extensions 250 which are inserted into openings 288. Valve 220 has an air exit face 290 positioned adjacent valve plate 100. Feed and release openings 292 and 294 are defined in valve 220. Likewise, first and second crack openings 296 and 298 are defined in valve in 220. Finally, reset openings which comprise first and second reset openings 300 and 302 are defined in valve 220. FIG. 47 is a view of the turret with the valve 220 adjacent the rotating valve plate 100 and the valve cover plate 224 and valve plate housing 102 disconnected. Valve 220 extends through a valve opening 303 in valve plate housing 102. Valve 220 may be allowed to slightly float against valve plate 100 in its installed position.

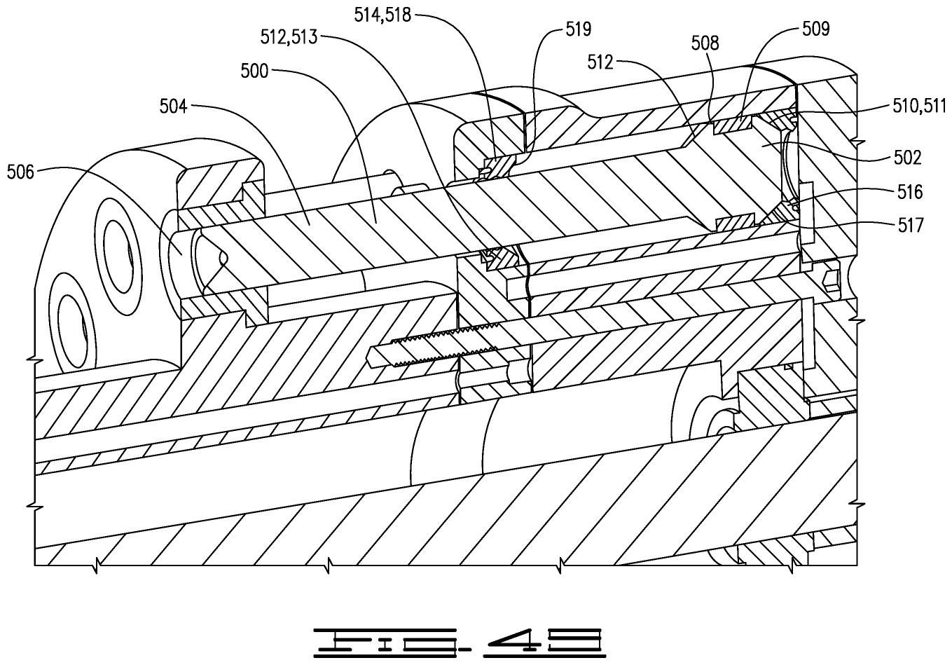

As described herein a nut cracking unit 42 comprises a piston 200 and associated shuttle 118 and crack die 130. As shown in a number of the figures, each nut cracking unit 42 has a plurality of openings in the turret 43 associated therewith. For example, each nut cracking unit 42 has a feed port 304, release port 306 a crack port 308 and a reset port 310 associated therewith in valve plate 100, as shown in FIG. 45. As the turret 43 rotates, when the nut cracking unit 42 is ready for receiving a nut shuttle 118 will be at the rear 122 of a shuttle cylinder 116 and the piston 200 will be in a retracted position 215. Turret 43 rotates clockwise from the vantage point FIG. 45. As turret 43 rotates, feed air will pass from feed air opening 264 in valve adapter plate 222 to opening 292 in valve 220 which will align with feed port 304 in valve plate 100. Feed air will pass through turret 43 and move piston 200 to the extended position 216 where it will hold a nut against crack die 130.

As the turret 43 continues to rotate, crack air will pass through opening 268 in valve adapter plate 222 and into crack opening 296 in valve 220 which will provide air through the crack opening or crack port 308. Crack air will move shuttle 118 forward to impact crack die 130 and crack a nut. This is the first crack position. Release air is then provided through release air port 266 in valve adapter plate 222 through release air opening 294 in valve 220 and release port 306 in valve plate 100. Release air will pass through turret 43 and will move piston 200 to the retracted position 215. Continued turret rotation will cause reset air to pass into the forward end of shuttle cylinder 116 to move the shuttle 118 to the rear 122 of the shuttle cylinder 118. Reset air passes from reset port 274 in valve adapter plate 222 through reset air port 302 in valve 220 and reset air port 310 in valve plate 100. This is the second reset position. After the release, a second crack occurs with air provided through second crack port 270 in valve adapter plate 222 and crack opening 308 in valve plate 100, and then another reset occurs through reset port 272 in valve adapter plate 222 and 300 in valve 220. This is referred to as the first reset.

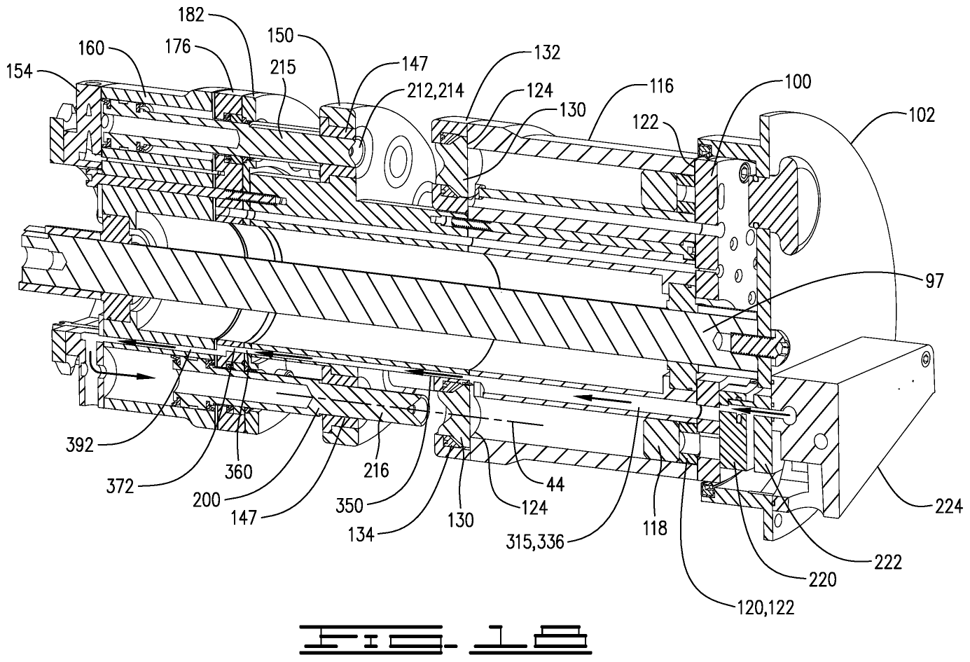

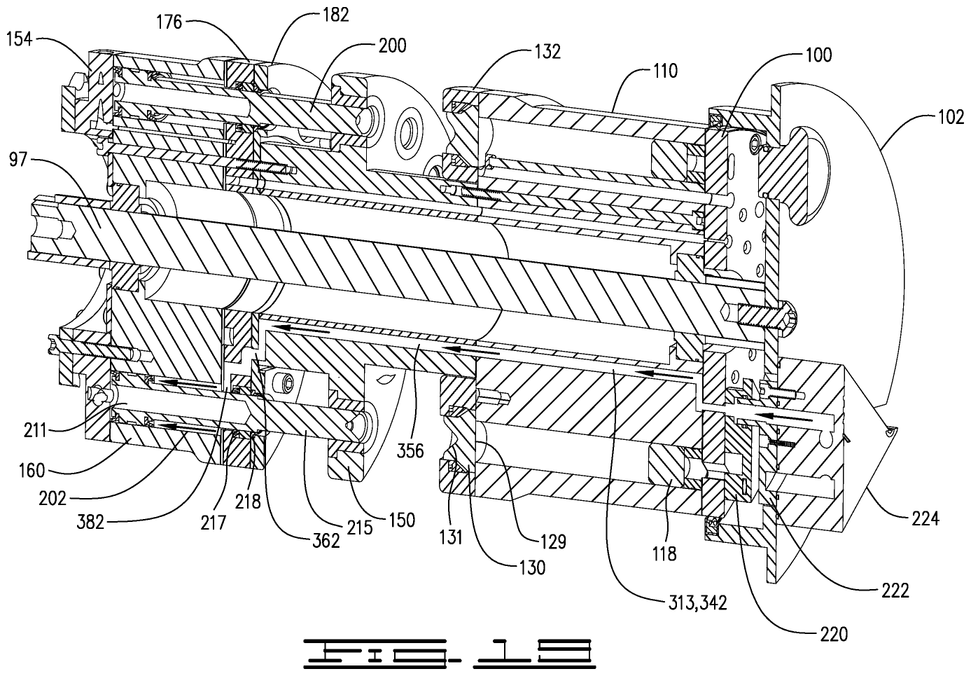

FIGS. 18-23 show the various positions of the nut cracking apparatus 5 and specifically the various positions of the nut cracking units 42. In the cross sections shown therein, certain features, for example the gaskets 108, 170, 174 and 161 are not seen simply as a result of the lack of thickness to those features. FIG. 19 shows the retracted position 215 of piston 200 of a nut cracking unit 42 prior to feed air being received. It also shows release air passage 313 through the turret. As shown therein, air is directed from the valve 220 through the turret 43 in passageway 313 that requires no external hoses or other fittings. Passage 313 is thus completely contained in turret 43. The retracted position 215 is likewise the release position as this is a position in which each nut cracking unit 42 is ready to be rotated to collect, or pick up a nut and proceed through the cracking process.

The extended, or feed position 216 showing a feed air passage 315 is shown in FIG. 18. Feed air passage 315 likewise requires no external hose or tubing and air is directed through the turret 43 so that it acts on the rear end 201 of piston cylinder 202 to urge piston 200 to the extended position. In the feed position the piston 200 will hold a pecan or other nut in place and will urge the nut against the crack die 130.

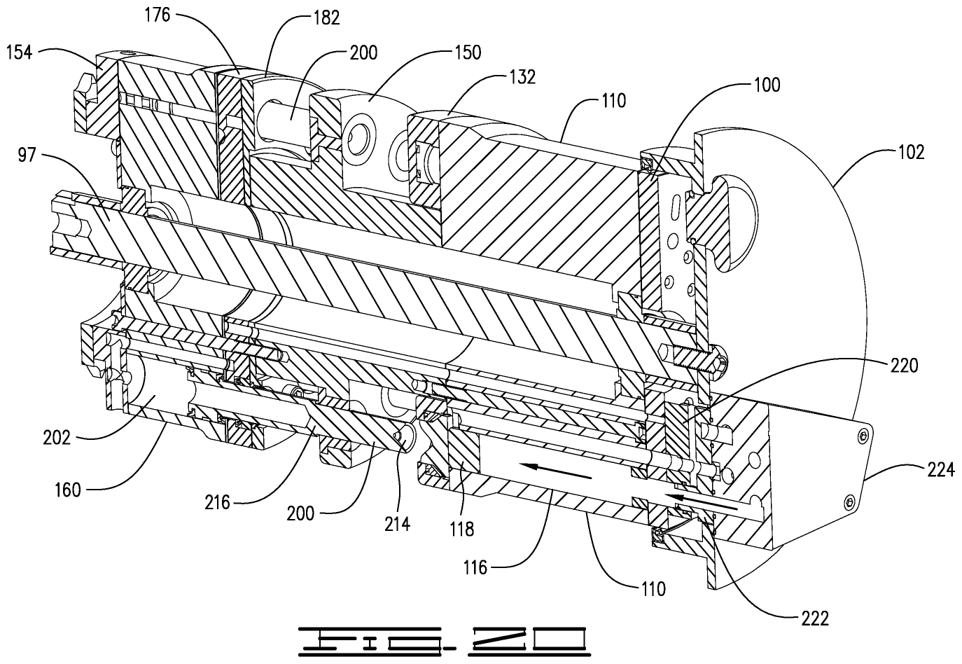

FIG. 20 shows the first crack position 316. In the first crack position 316 of the nut cracking unit 42 air is fed through valve 220 to the rear end 122 of shuttle cylinder 116 to urge the crack shuttle 118 in a direction toward the crack die 130. As a result, the nut being held between the piston 200 and the crack die 130 will be cracked. Air is provided directly from valve 220 through valve plated into the rear end 122 of shuttle cylinder 116. As noted before, FIG. 19 shows the release position into which piston 200 is moved after the first crack. The second reset position is shown in FIG. 21 which shows a reset passage 319. This is referred to as the second reset since it occurs after the initial crack. Air is communicated directly into reset passage 319 from valve 220 through rotating valve plate 100. Reset passage 319 is defined in shuttle cylinder housing 110 and provides air to the forward end of shuttle cylinder 116 to move shuttle 118 to the reset position.

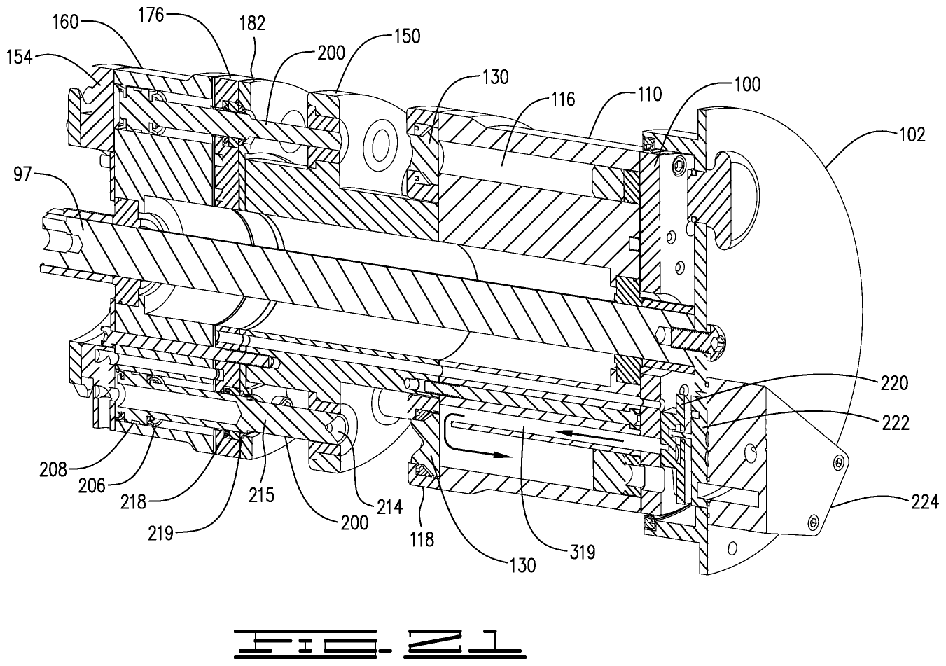

FIG. 22 shows the second crack referred to as the second crack position. The second crack is utilized to remove any shell fragments or other residue that might be lodged in the crack die so that as the nut cracking unit 42 picks up another nut it will maintain a straight efficient cracking position. The crack air for the second crack is provided directly to the rear end 122 of shuttle cylinder 116 through the valve plate 100 after the air exits valve 220. A first reset position is shown in FIG. 23. This is the first reset position in that it is the operation that must occur prior to the rotation of the turret 43 so that the nut cracking unit 42 can engage a nut to proceed with the cracking process. The first and second resets occur through the same passage 319 after the air exits valve 220.

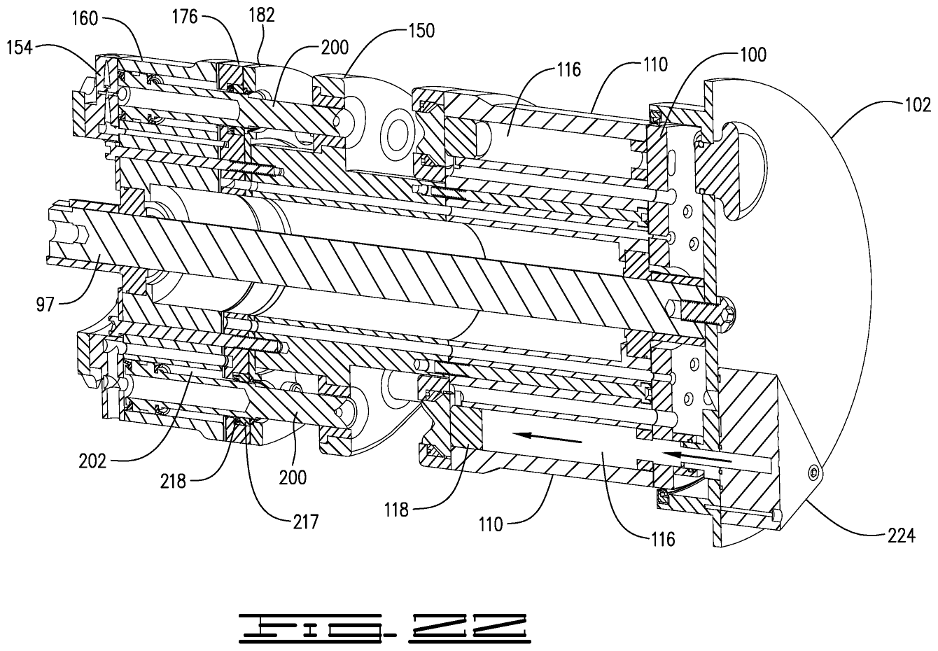

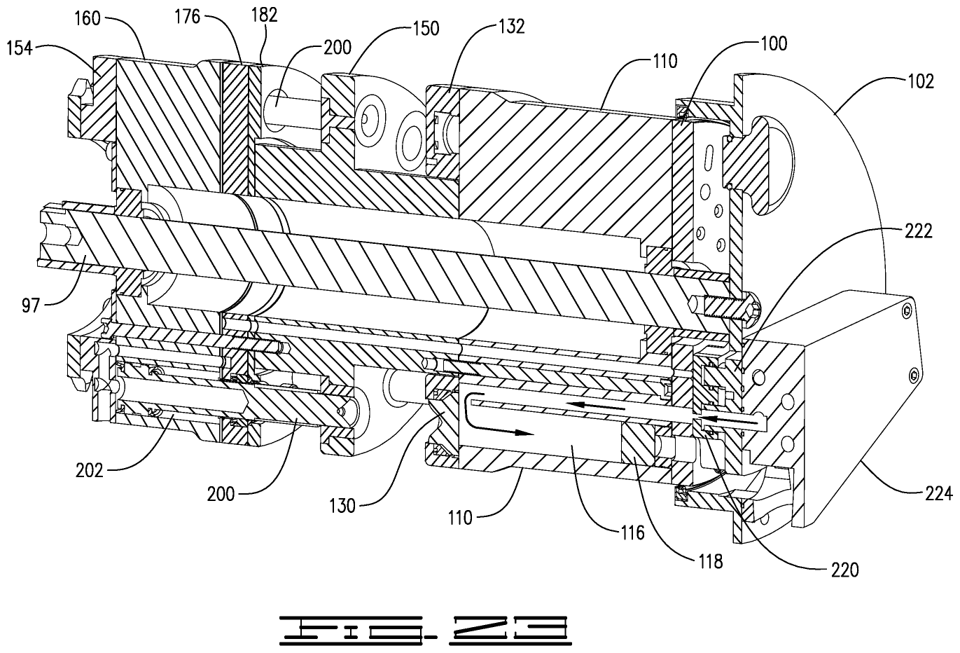

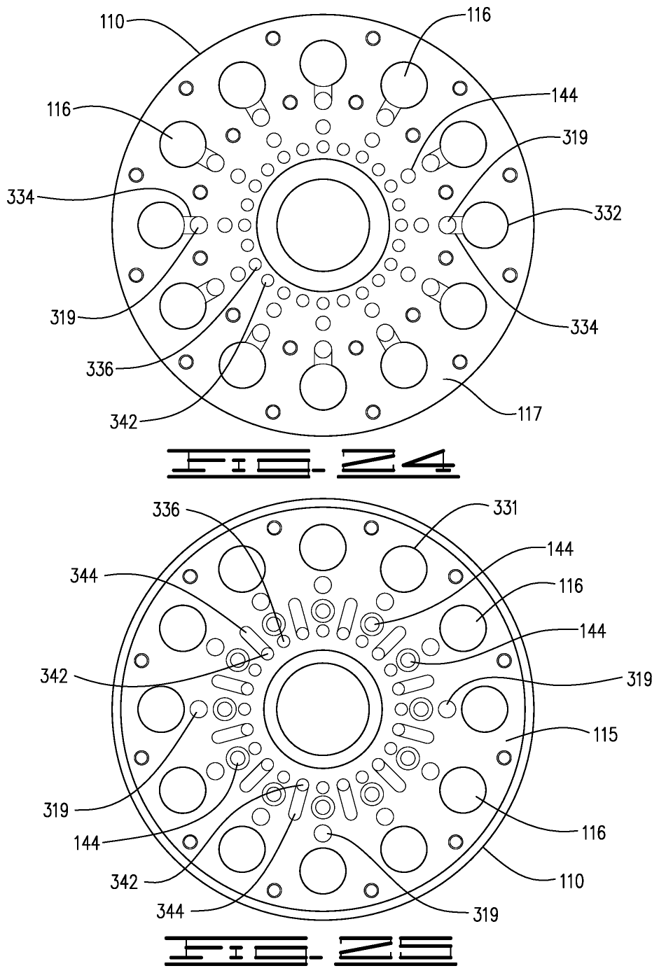

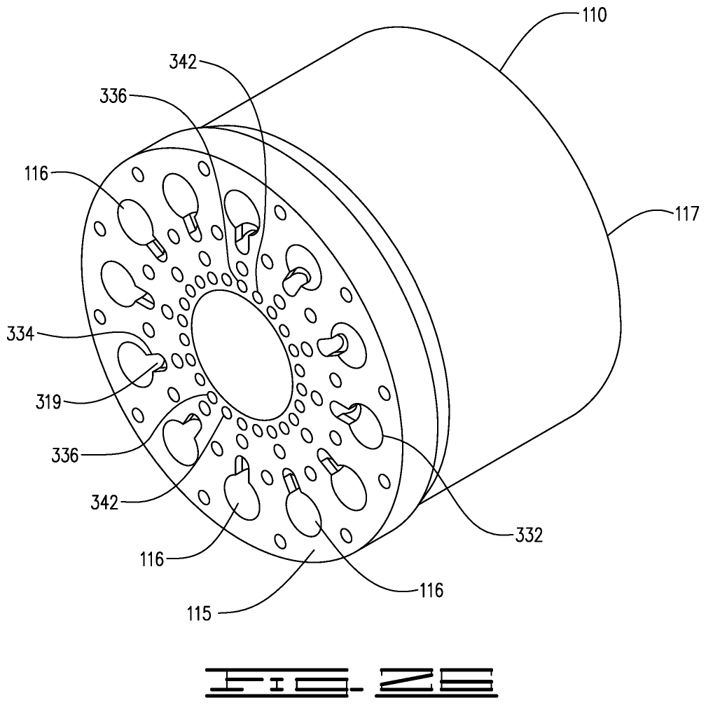

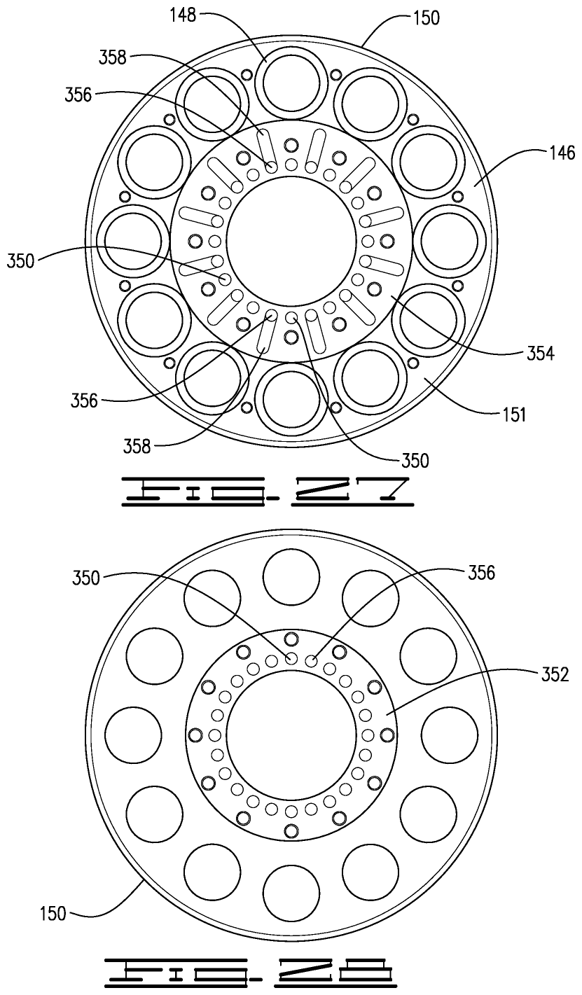

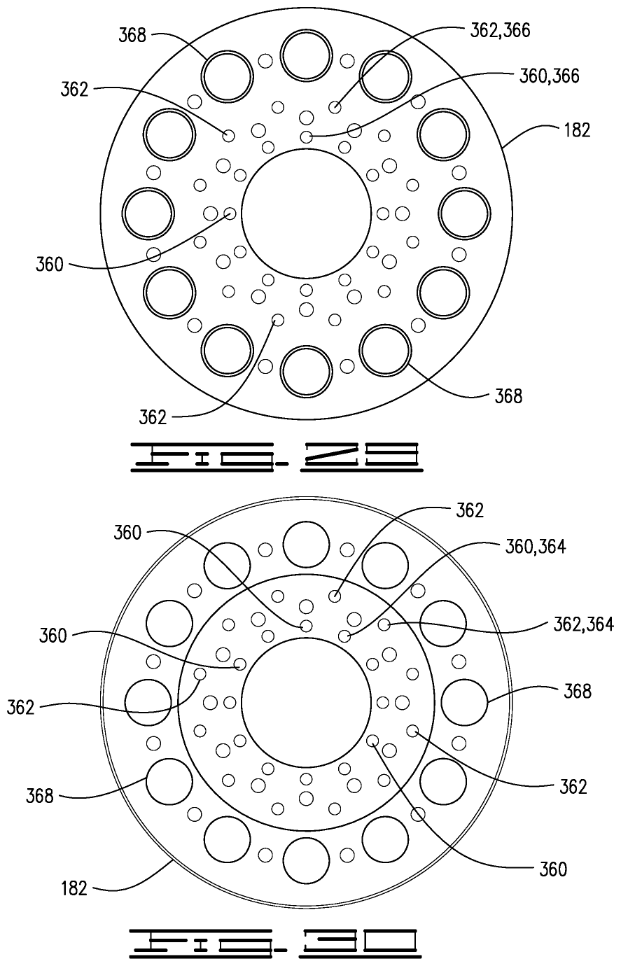

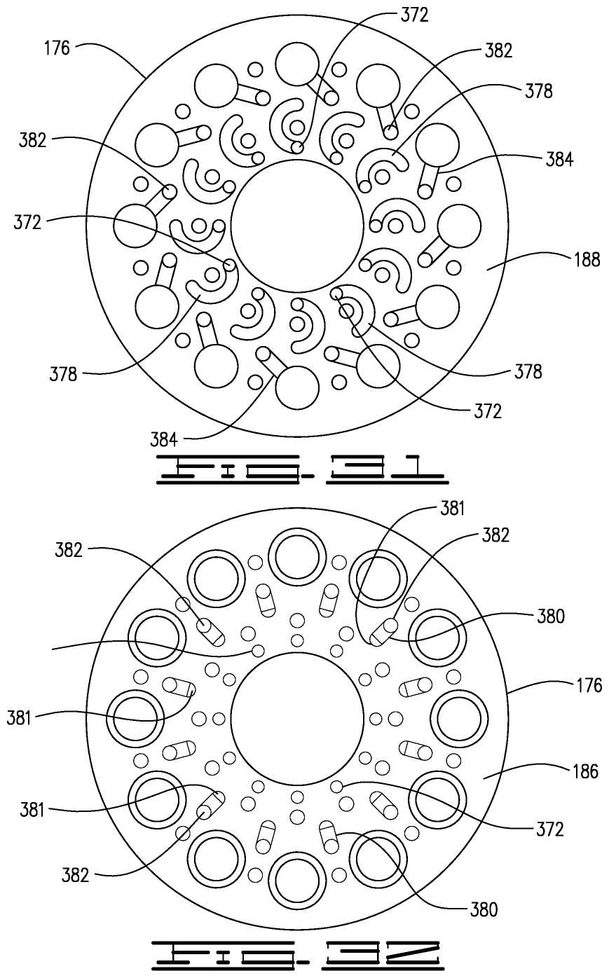

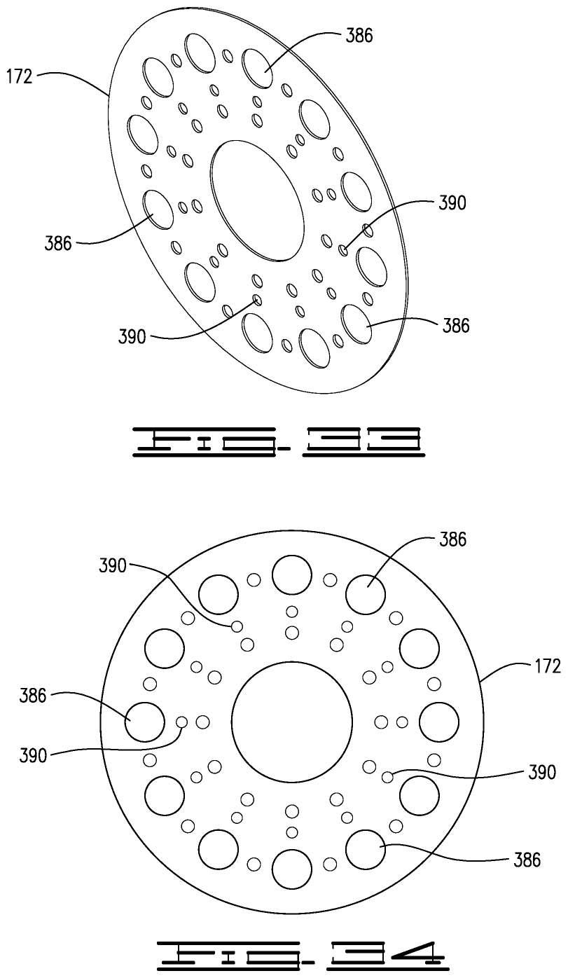

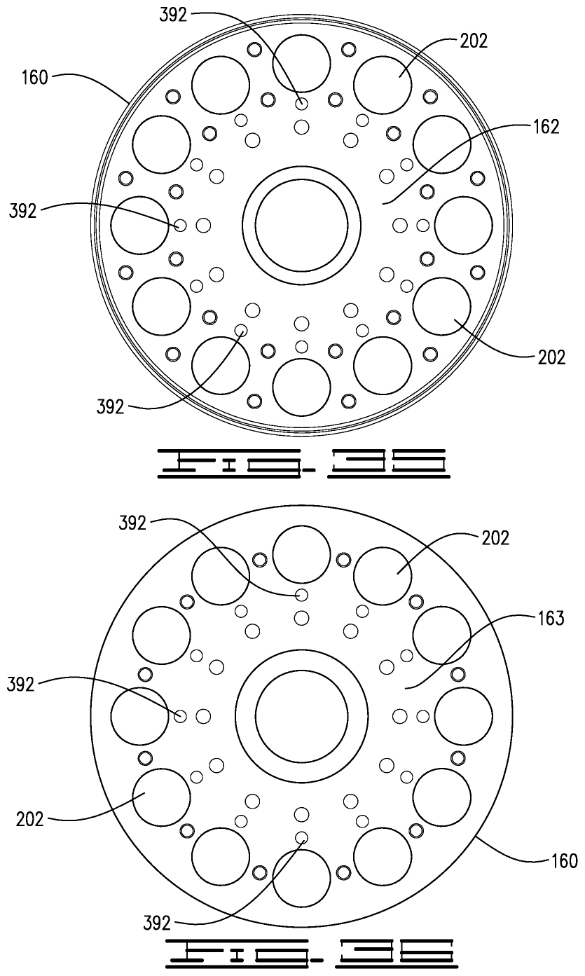

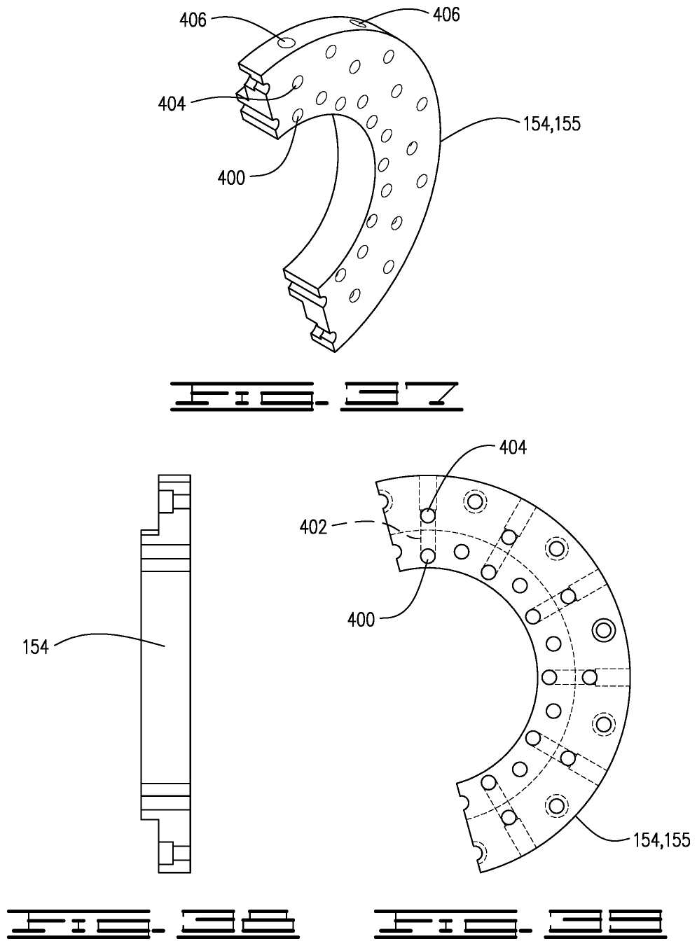

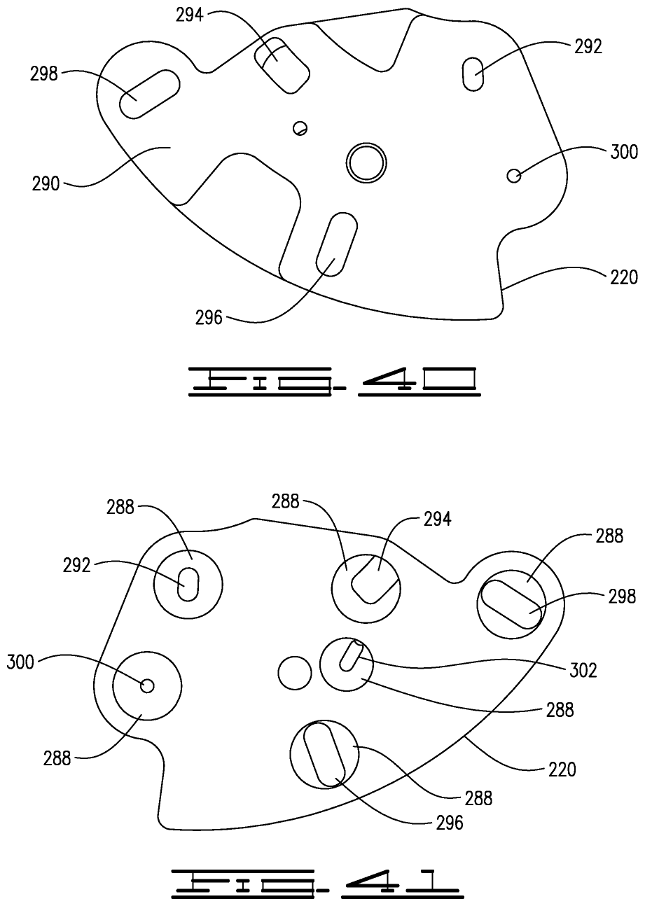

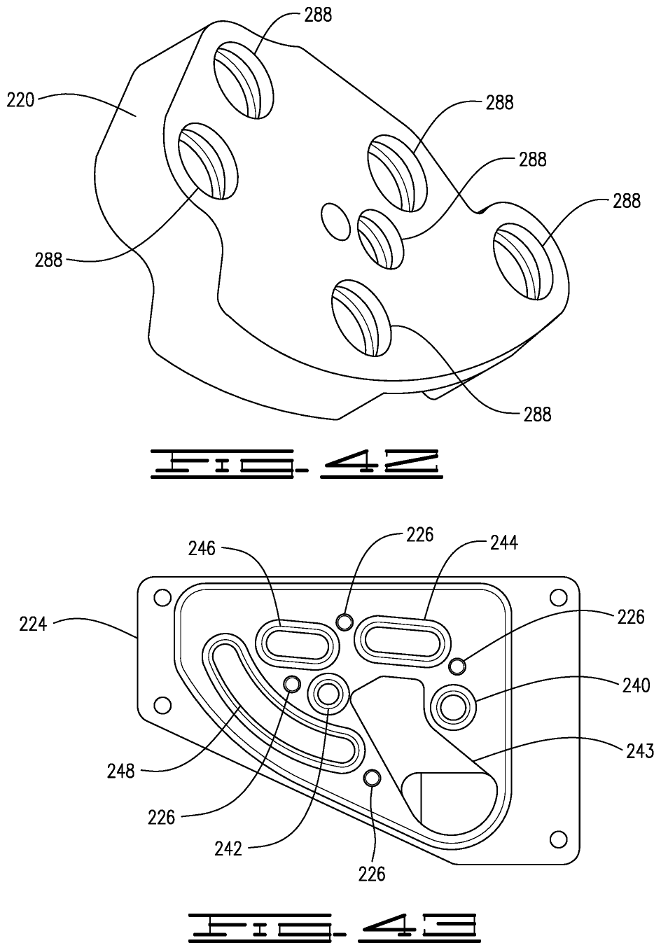

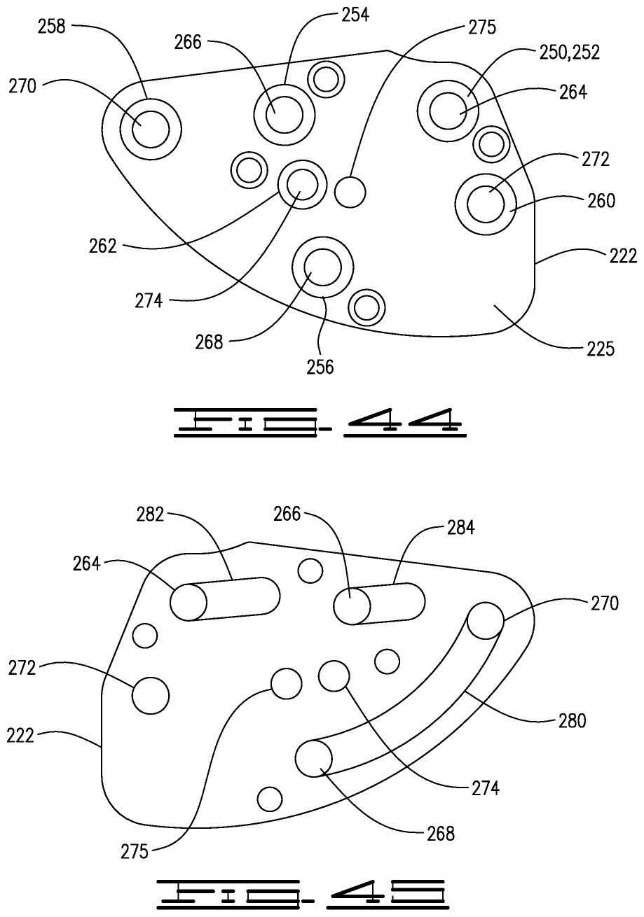

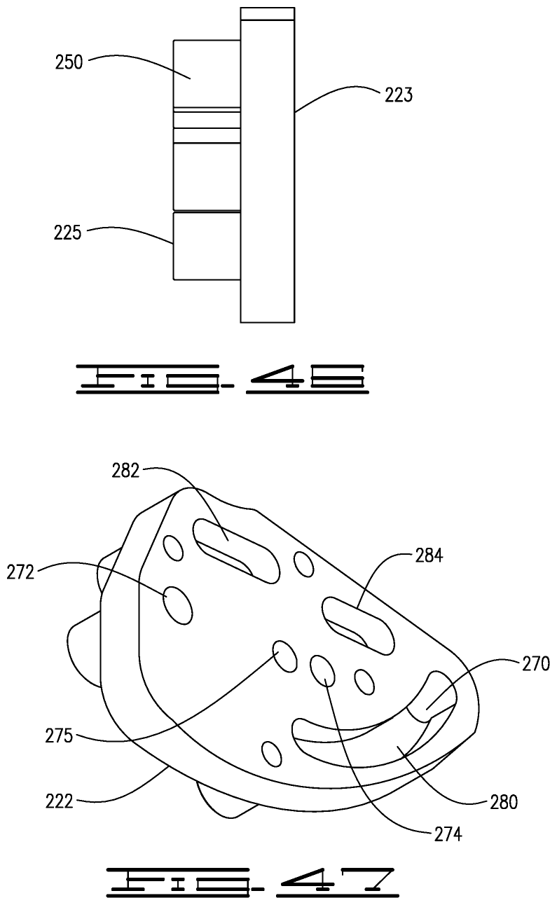

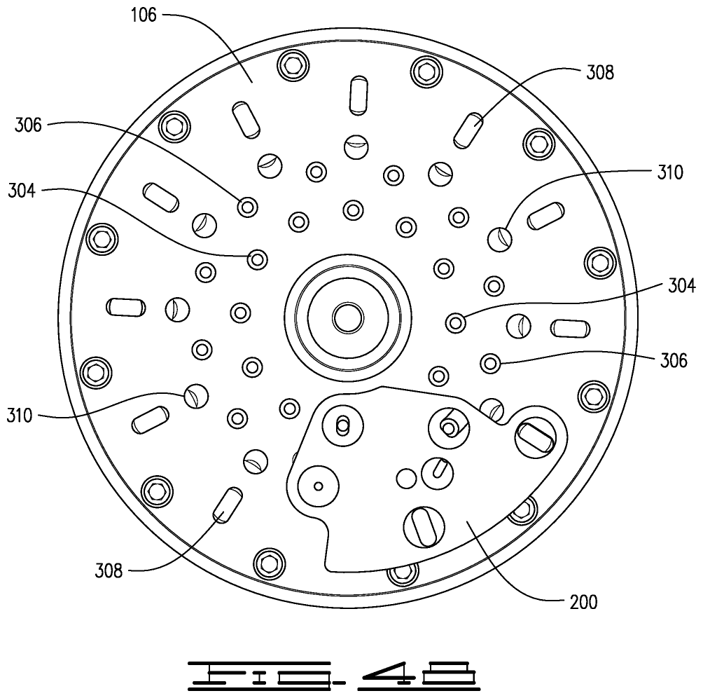

FIGS. 24-26 show details of shuttle cylinder 110. As noted, shuttle cylinder housing 110 has a plurality of shuttle cylinders 116. Shuttles 118 are positioned in shuttle cylinders 116 for movement therein as described. Each shuttle 118 comprises a part of a nut cracking unit 42. Shuttle cylinder housing 110 has a reset passage 319 defined therethrough from an entry end 331 to an exit end 332. A connecting slot 334 is defined in exit end 332 of shuttle cylinder 116 so that reset air will pass through reset passage 319 and be communicated from slot 334 to the forward end 124 of shuttle cylinder 116 to urge shuttle 118 to the rear end 122 of the shuttle cylinder 116. The reset air for the first reset passes from the valve plate 100 into reset passage 319. Crack air is provided directly to the rear end of the shuttle cylinder 116.

Shuttle cylinder housing 110 has feed air passages 336 extending therethrough from an entrance end or air entry end 115 to the exit end or air exit end 117 of shuttle cylinder housing 110. Feed passages 336 will receive feed air from feed port 304 in valve plate 100.

Shuttle cylinder housing 110 has a release port 342 extending from air entry end 115 to the air exit end 117. Release air will be provided through release port 306 in valve plate 100 and will be received in a slot 344 defined in the entry end 115 of shuttle cylinder 110. Release air is communicated from slot 344 into a release air port 342.

Center hub 150 has a plurality of feed air passages 350 extending from the air entry end 149 to the air exit end 151 thereof. Center hub 150 also defines a release passage 356 therethrough from entry end 149 to exit end 151. Center hub 150 has a first hub portion 352 and a second hub portion 354. First hub portion 352 is at the entry side, and second portion 354 is at the exit side. It is apparent from the drawings that first hub portion 352 will fit through opening 142 defined in crack die holder 132. A connecting slot 358 extends radially outwardly from release air passage 356 at the exit end thereof. Air passes from slot 344 in shuttle cylinder 110 into release port 342 and into release air passage 356 in center hub 150. Feed air passes directly from feed air passages 336 into feed air passages 350 in center hub 150.

Cylinder seal plate 182 is positioned adjacent second hub portion 354. A gasket 183 may be positioned between cylinder seal plate 182 and second hub portion 354. Cylinder seal plate 182 has a plurality of feed ports 360 therethrough and a plurality of release ports 362 therethrough. Feed ports 360 and release ports 362 extend from an air entry end 364 to an air exit end 366 thereof. Feed air will be received from feed passages 350 in central hub 150 and will pass through cylinder seal plate 182. Release air will pass radially outwardly from release passages 356 in center hub 150 in connecting slots 358 and will pass into release ports 362 in cylinder seal plate 182 at the entry end 364 thereof. Cylinder seal plate 182 has openings 368 which allow the reciprocation of pistons 200 therethrough. Cylinder head gasket 180 has openings 369 and 371 to provide for the passage of feed air from feed port 360 and release air from release port 362 therethrough.

Cylinder head plate 176 has a plurality of feed air passages 372 extending from the air entry end 186 to the air exit end 188 thereof. The exit end of cylinder head plate 176 has an eyebrow-shaped communicating slot 378 which as explained below will communicate feed air to the rear end 201 of each piston cylinder 202 which is the feed end of each piston cylinder 202. A release air slot 380 receives release air at a bottom end 381 thereof from ports 362 in cylinder seal plate 182. Slot 380 extends only partially through cylinder head plate 176 and once air is received from port 362 it will pass through slot 380 into a release air port 382. Release air port 382 will communicate air through a release air delivery slot 384 into the release or forward end 203 of the piston cylinder 202 in cylinder body 160. Release air will pass through the piston rod openings 386 in cylinder front plate 172 and in mating openings in the cylinder body gasket 170. Air received therein will urge piston rod 210 toward the rear end of the piston cylinder 202. Feed air will pass through feed air passage 372 and will be communicated by arcuate slot 378 into a feed air port 390 in cylinder front plate 172.

Cylinder body 160 has a feed air port 392 that extends from the air entry end 163 to the air exit end 162 thereof. Air passes from feed air port 392 into a feed air port 400 defined in cylinder end plate 154. Feed air passes into feed air port 400 and through a connecting passage 402 defined in cylinder end plate 154. Feed air is then passed through an exit feed air port 404 where it acts on piston rod 210 to urge piston rod 200 to the feed position shown in FIG. 18. Because cylinder end plate 154 is sectioned, it provides for easy removal and the easy extraction of selected pistons 200. One of the advantages of the design of the current disclosure is that pistons 200 may be easily removed and replaced since the turret 43 is internally ported as opposed to having external air tubing for driving pistons.

In operation, the motor is operated at a desired speed and an air supply provides air to a manifold 408. The manifold will supply air to regulators associated with feed, release, reset and crack control knobs 410, 412, 414 and 416. Air will be fed from the manifold 408 to the feed, release, reset and crack openings 226, 228, 230 and 232 in valve cover plate 224. The feed and crack air may be passed through a lubricator to help seal moving parts associated with the shuttles 118 and pistons 200. Cracker apparatus 5 will crack at high speeds, as much as 750 nuts per minute. Air used to move pistons 200 between the extended and retracted positions 215 and 216 passes through turret assembly 43 directly from valve 220 with no external tubing or hoses. Feed passage 315 comprises passage 336 in shuttle cylinder 110, passage 350 in turret center hub 150, port 360 in cylinder seal plate 182, passage 372 in cylinder head plate 176, port 390 in cylinder front plate 172 and port 392 in cylinder body 160 where it is delivered through cylinder end plate 154 to piston cylinder 202. Release passageway 313 likewise passes from valve 220 all the way to the front end of the cylinder body 160 and is comprised of port 342 in shuttle cylinder housing 110, passage 356 in center hub 150, port 362 in cylinder seal plate 182 and port 382 in cylinder head plate 176. First and second portions 155 and 156 of cylinder end plate 154 are easily removed, which provides easy access for the removal of selected pistons 200. Pistons 200 may be easily removed and replaced, and there is no danger of connecting hoses to an incorrect air port, since there are no external air ports or hoses providing air to the pistons 200.

As conveyor 62 moves, nuts are picked up in nut pockets 84. The nut pockets 84 deliver nuts to the pickup point 86. Feed air is delivered through feed passage 315 and piston 200 moves to the feed position to hold a nut against the crack die 130. Crack air is applied, and the shuttle 118 moves into crack die 130 to crack the nut. Crack die 130 will move slightly when impacted by shuttle 118. The distance that crack die 130 moves can be adjusted by adding a shim of a desired width between crack die holder 132 and shuttle cylinder housing 110, or by adjusting the length of the crack die 130. Exhaust opening 243 allows air to be exhausted from the system as the pistons 200 and shuttles 118 move during the cracking process.

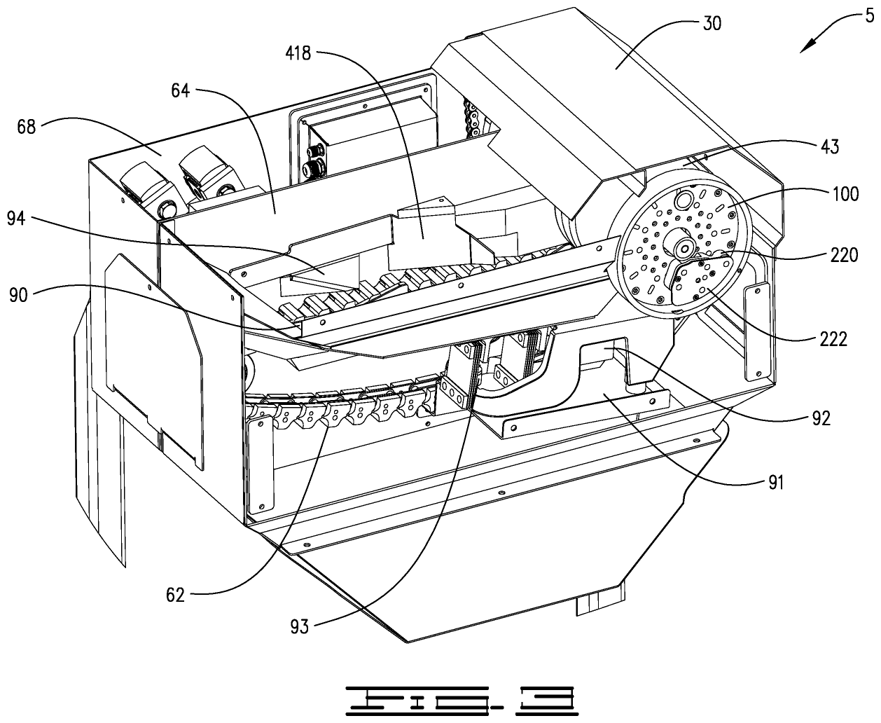

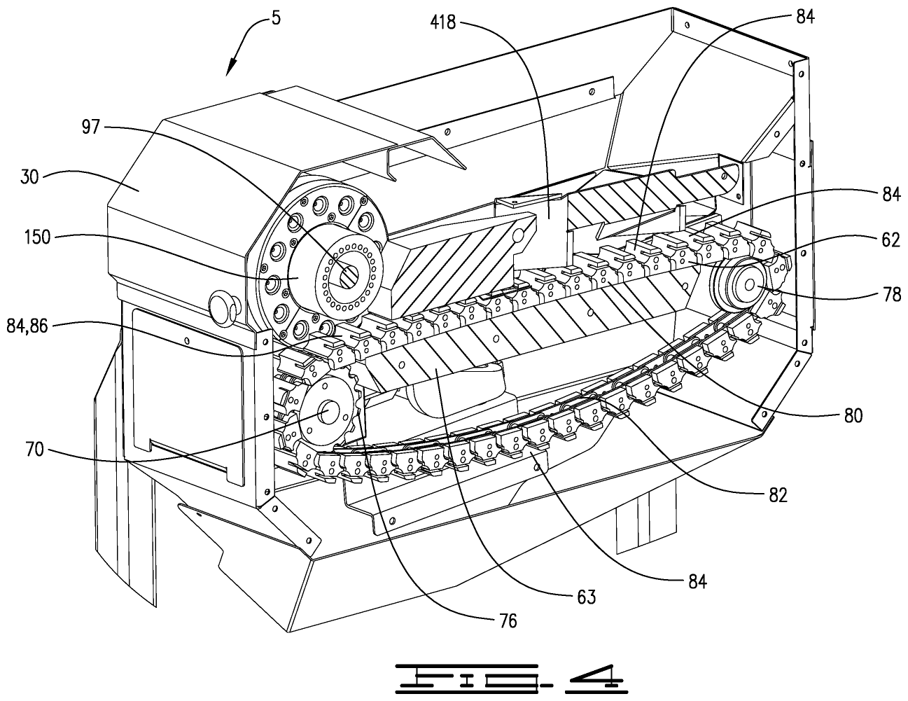

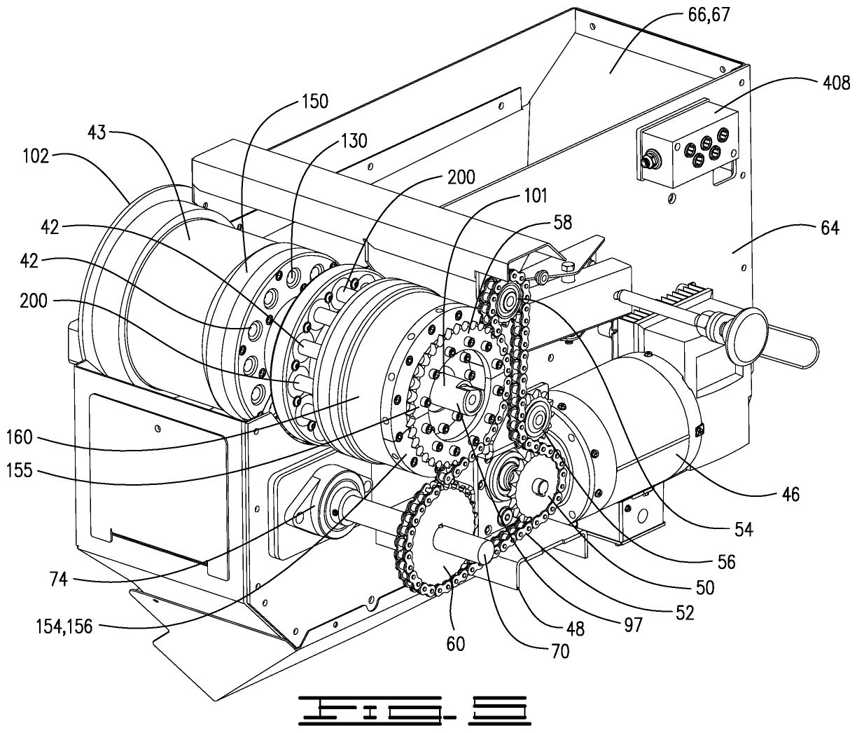

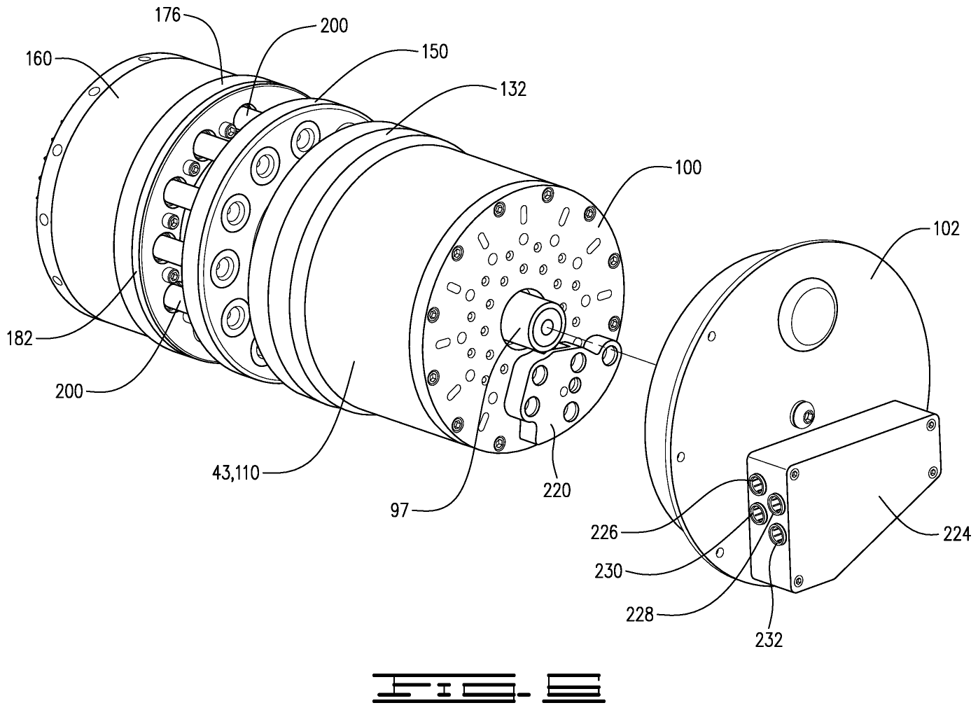

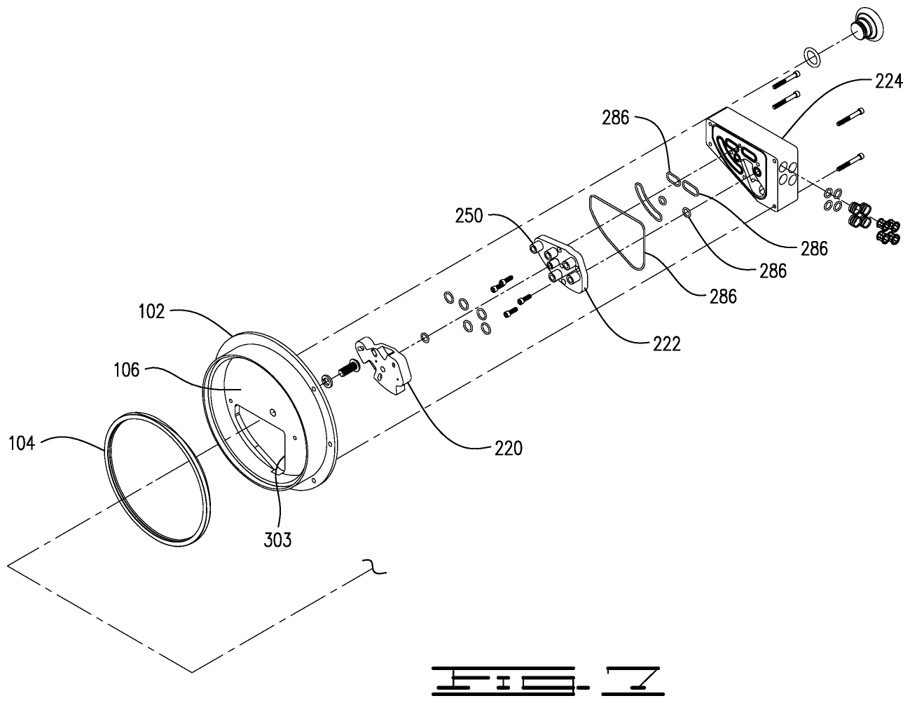

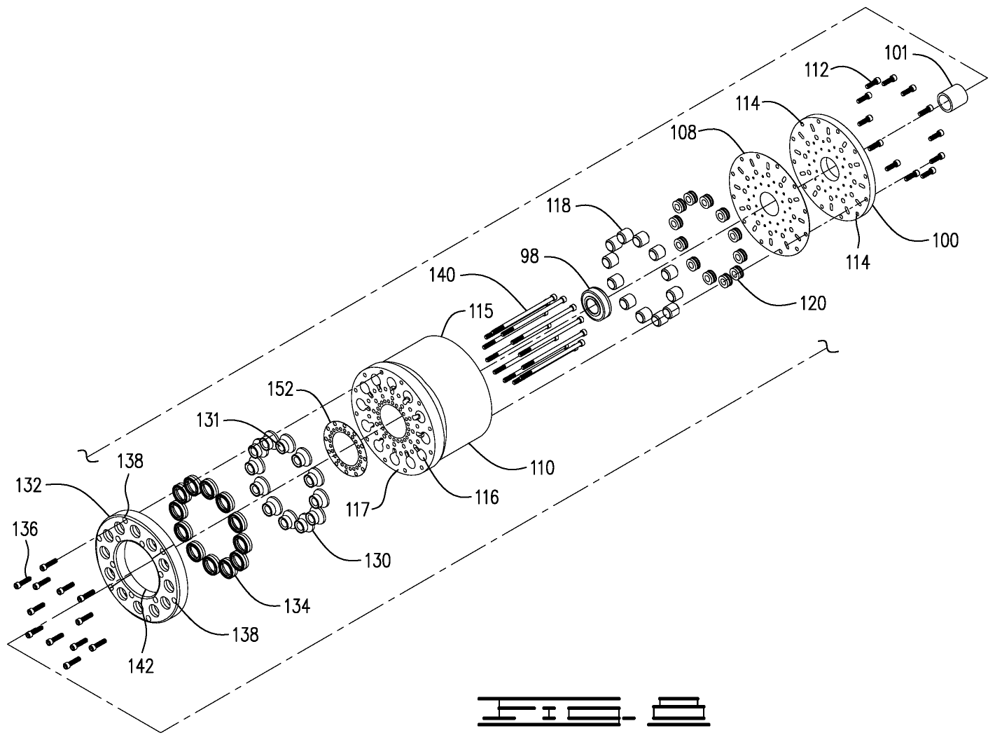

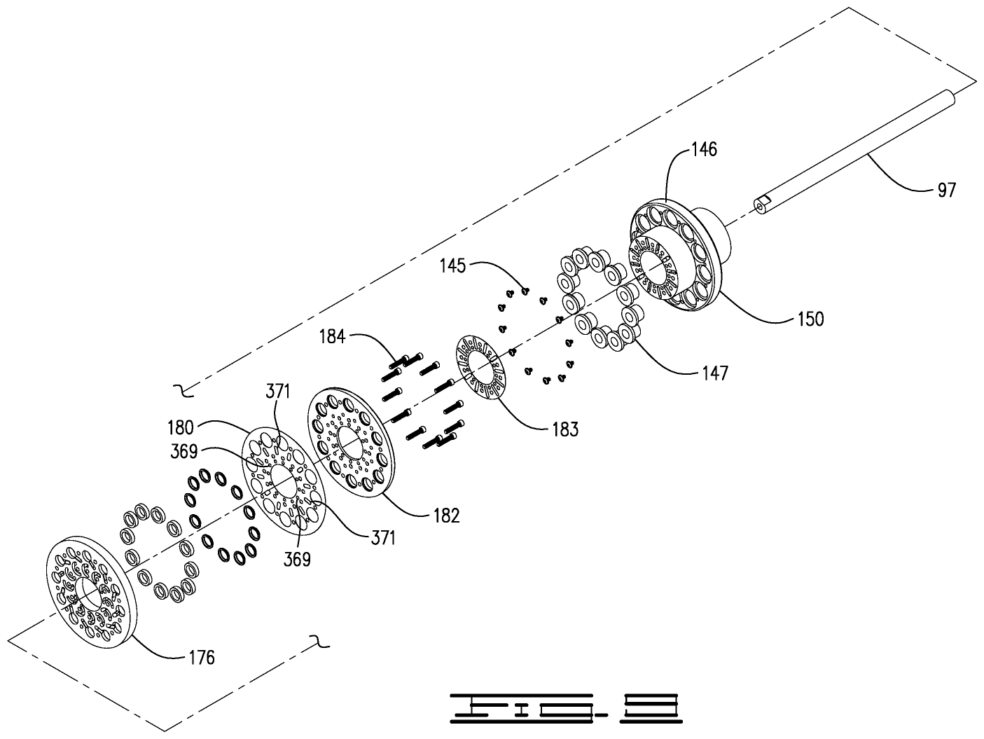

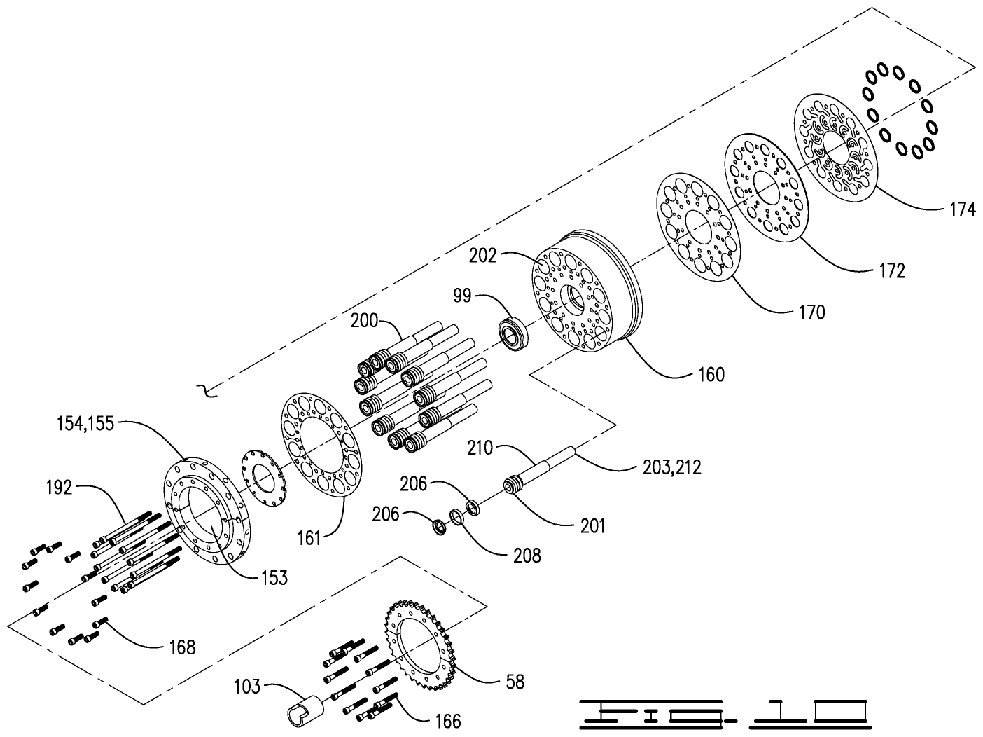

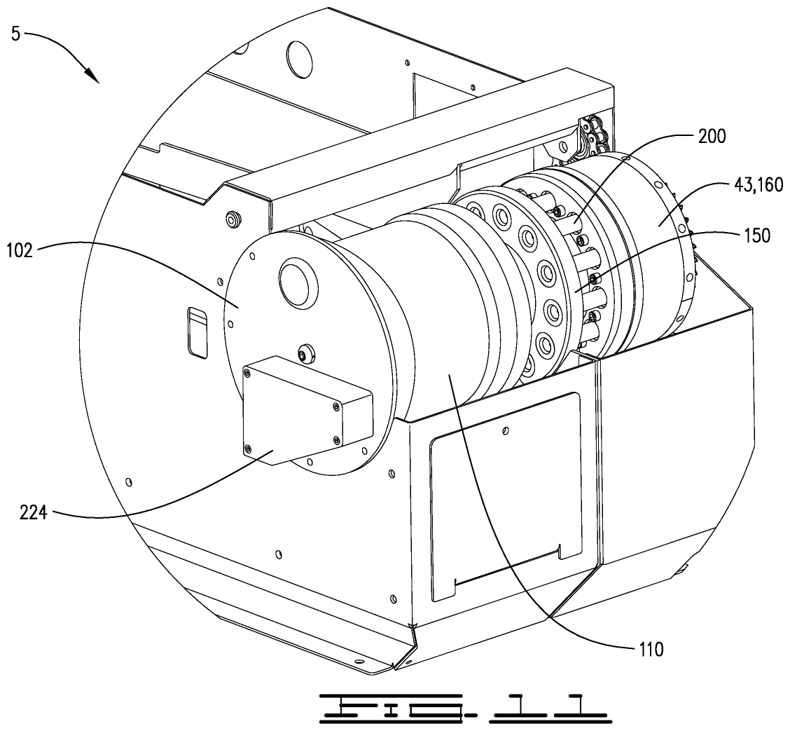

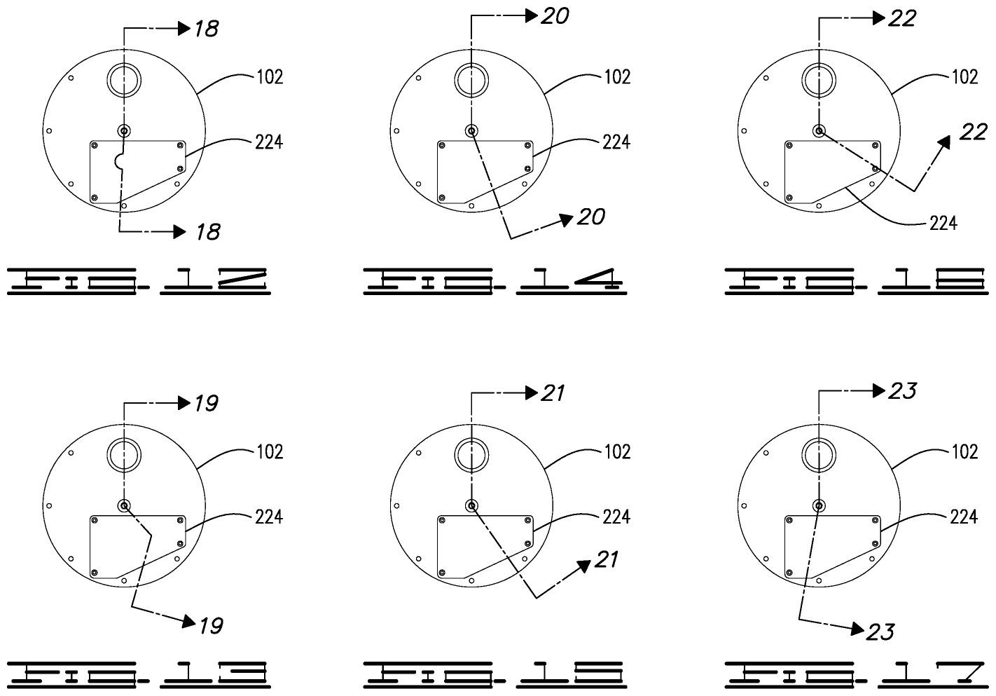

A singulator 418, best seen in FIG. 3, is pivotally mounted to a bracket that is connected to center divider 64. Singulator 418 will extend through a slot in the center divider and into a slot in the nut chain 80. The singulator is adjustable, and the width of the nut chain 80 is such that the singulator 418 will ensure that only one nut will fit in any single nut pocket. In other words, two nuts will not fit end to end in a single nut pocket. The singulator 418 may have a curvature if necessary to match the travel path of the endless conveyor 62.

Embodiments include.

Embodiment 1. A nut cracking apparatus comprising a frame; a rotatable turret mounted to the frame, the rotatable turret including a rotatable valve plate at an end thereof; a plurality of nut cracking units in the rotatable turret. Each nut cracking unit comprises a piston movable from a retracted position to an extended position; and a crack die aligned with the piston against which the piston secures a nut in its extended position. An air supply is communicated with the rotatable valve plate, the rotatable turret defining a feed air passage associated with each nut cracking unit therethrough from the rotatable valve plate to a rear end of a piston cylinder in which the piston is housed through which air passes to urge the piston from a retracted to an extended position.

Embodiment 2. The nut cracking apparatus of embodiment 1 further comprising a stationary valve positioned adjacent the rotatable valve plate, the stationary valve defining a feed air opening therethrough communicated with the air supply, the rotatable valve plate having a feed air opening associated with each nut cracking unit, feed air being sequentially supplied from the feed air opening in the stationary valve to the feed air openings in the rotatable valve plate into the feed air passages as the rotatable turret rotates.

Embodiment 3. The nut cracking apparatus of either of embodiments 1 or 2, the nut cracking apparatus of claim 2, each nut cracking unit further comprising a shuttle cylinder having a shuttle disposed therein movable in the cylinder from a rear end toward a forward end to impact the crack die.

Embodiment 4. The nut cracking apparatus of either of embodiments 2 or 3, the stationary valve having first and second crack air openings communicated with the air supply, the rotating valve plate having a single crack air opening associated with each nut cracking unit through which crack air is provided twice from the stationary valve to a rear end of a shuttle cylinder to urge the shuttle into the crack die of the nut cracking unit during a single rotation of the rotatable turret.

Embodiment 5. The nut cracking apparatus of any of embodiments 1-4 the rotatable turret defining a release air passage therethrough associated with each nut cracking unit from the rotatable valve plate to a forward end of the piston cylinder through which release air is communicated to urge the piston from an extended to a retracted position.

Embodiment 6. The nut cracking apparatus of any of embodiments 3-5, the shuttle movable into the crack die a first time during a rotation of the turret to crack a nut when the piston is in an extended position upon the application of air to the rear end of the shuttle cylinder and movable into the crack die a second time during the same rotation of the turret.

Embodiment 7. The nut cracking apparatus of any of embodiment 1 the rotatable turret comprising a piston cylinder body defining a plurality of piston cylinders; a shuttle cylinder housing defining a plurality of shuttle cylinders; and a shuttle in each shuttle cylinder movable from a rear end of the shuttle cylinder to a forward end to impact the crack die of the nut cracking unit, the piston cylinder body and shuttle cylinder body defining air passages therethrough that form at least a portion of the feed air passages associated with each nut cracking unit.

Embodiment 8. A nut cracking apparatus comprising: a frame; a piston cylinder body rotatably mounted in the frame, the piston cylinder body defining a plurality of piston cylinders with a piston movably disposed therein from a retracted position to an extended nut holding position; a shuttle cylinder housing rotatable with the piston cylinder body, the shuttle cylinder housing defining a plurality of shuttle cylinders each with a shuttle movably disposed therein; a crack die positioned at a forward end of each shuttle cylinder, the shuttle movable from a rear end to a forward end of the shuttle cylinder to impact the crack die; and an air supply communicated with a rear end of the shuttle cylinder body, the air supply providing air to the rear end of the shuttle cylinder to move the shuttle in the shuttle cylinder twice to generate first and second impacts on the crack die during a single rotation of the shuttle cylinder body.

Embodiment 9. The nut cracking apparatus of embodiment 8, one of the first and second impacts occurring to crack a nut held between the piston and crack die when the piston is in the extended position, the other of the first and second impacts occurring after a nut has been cracked.

Embodiment 10. The nut cracking apparatus of either of embodiments 8 or 9, the shuttle cylinder housing and piston cylinder body each defining a plurality of feed air passages therethrough, each feed air passage in the shuttle cylinder housing communicated with a feed air passage in the piston cylinder body, each feed air passage in the piston cylinder body communicated with a rear end of a piston cylinder to communicate feed air thereto.

Embodiment 11. The nut cracking apparatus of embodiment 10, further comprising a center hub positioned between the shuttle cylinder housing and the piston cylinder body, the center hub having a plurality of feed air passages therethrough communicating the feed air passages in the shuttle cylinder body with the feed air passages in the piston cylinder body.

Embodiment 12. The nut cracking apparatus of embodiments 10 or 11, further comprising a valve plate connected to and rotatable with the shuttle cylinder body and a stationary valve positioned adjacent the valve plate, the feed air provided to the feed air passages in the shuttle cylinder body through the stationary valve and the valve plate.

Embodiment 13. The nut cracking apparatus of any of embodiments 10-12, further comprising a cylinder end plate connected to the piston cylinder housing and defining a plurality of ports therethrough communicating the feed air passages in the piston cylinder body with a rear end of the piston cylinders.

Embodiment 14. The nut cracking apparatus of any of embodiment 13, the cylinder end plate comprising first and second end plate sections removably connected to the piston cylinder housing.

Embodiment 15. A nut cracking apparatus comprising a frame; a rotatable turret mounted to the frame; a turret sprocket connected to the rotatable turret; a drive sprocket connected to and rotated by a motor; a chain engaging the drive sprocket and turret sprocket, the turret sprocket rotated by the motor, the rotating turret comprising: a plurality of pistons movable in piston cylinders from a retracted position to an extended nut holding position; a plurality of shuttles movable in shuttle cylinders from a rear end to a forward end thereof; and a plurality of crack dies positioned at the forward end of the shuttle cylinders; a rotatable valve plate positioned adjacent the rear end of the shuttle cylinders; The nut cracking apparatus further comprising an air supply communicated with a stationary valve positioned adjacent the rotatable valve plate; and the turret defining air passages for providing air communicated through the rotatable valve plate to the piston cylinders and shuttle cylinders to move the pistons and shuttles in their respective cylinders, the air passages being completely contained within the rotating turret.

Embodiment 16. The nut cracking apparatus of embodiment 15 comprising a plurality of nut cracking units, each nut cracking unit comprising one of the plurality of pistons, one of the plurality of crack dies and one of the plurality of shuttles, the valve plate defining a plurality of air ports communicable with each nut cracking unit to move the pistons and shuttles in the piston cylinders and shuttle cylinders.

Embodiment 17. The nut cracking apparatus of either of embodiments 15 or 16, the stationary valve defining first and second crack air openings, crack air being supplied to a rear end of each shuttle cylinder from the first and second crack openings through the rotatable valve plate during a single rotation of the valve plate to impact the crack die with the shuttle first and second times during the single rotation.

Embodiment 18. The nut cracking apparatus of any of embodiments 15-17 the rotatable turret comprising a piston cylinder body defining the piston cylinders, the piston cylinder body defining a feed air passage for communicating feed air to a rear end of each piston cylinder; and a shuttle cylinder housing defining the shuttle cylinders, the shuttle cylinder housing defining a feed air passage for communicating air to the feed air passage in the piston cylinder body.

Embodiment 19. The nut cracking apparatus of embodiment 18 further comprising a center hub positioned between the piston cylinder body and the shuttle cylinder housing, the center hub having feed air passages communicating the feed air passages in the shuttle cylinder housing with the feed air passages in the piston cylinder body.

Embodiment 20. The nut cracking apparatus of any of embodiments 15-19 being less than 28″ wide, 22″ high and 41″ long and capable of cracking nuts at a rate in excess of 750 nuts/minute.

Embodiment 21. A nut cracking apparatus comprising: a frame; a rotatable turret mounted to the frame; a plurality of nut cracking units in the rotatable turret. Each nut cracking unit comprises a piston having a piston head and a piston rod extending therefrom movable in a piston cylinder from a retracted position to an extended position and a crack die aligned with the piston against which the piston secures a nut in its extended position. A forward seal defining a frustoconical engagement surface is positioned at a forward end of each of the piston cylinders and a rear seal defining a frustoconical engagement surface is positioned at a rear end of each of the piston cylinders. The piston head comprises a generally cylindrical center portion sealingly engaged with the piston cylinder and a rear portion sloping radially inwardly in a rear direction from the center portion and defining a rear engagement surface for mating with the frustotoconical engagement surface on the rear seal.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention.

What is claimed is:

1. A nut cracking apparatus comprising:
a frame;
a rotatable turret mounted to the frame, the rotatable turret including a rotatable valve plate at an end thereof;
a plurality of nut cracking units in the rotatable turret, each nut cracking unit comprising:
a piston movable from a retracted position to an extended position; and
a crack die aligned with the piston against which the piston secures a nut in its extended position; and
an air supply communicated with the rotatable valve plate, the rotatable turret defining a feed air passage associated with each nut cracking unit therethrough from the rotatable valve plate to a rear end of a piston cylinder in which the piston is housed through which air passes to urge the piston from a retracted to an extended position.

2. The nut cracking apparatus of claim 1, further comprising a stationary valve positioned adjacent the rotatable valve plate, the stationary valve defining a feed air opening therethrough communicated with the air supply, the rotatable valve plate having a feed air opening associated with each nut cracking unit, feed air being sequentially supplied from the feed air opening in the stationary valve to the feed air openings in the rotatable valve plate into the feed air passages as the rotatable turret rotates.

3. The nut cracking apparatus of claim 2, each nut cracking unit further comprising a shuttle cylinder having a shuttle disposed therein movable in the cylinder from a rear end toward a forward end to impact the crack die.

4. The nut cracking apparatus of claim 3, the stationary valve having first and second crack air openings communicated with the air supply, the rotating valve plate having a single crack air opening associated with each nut cracking unit through which crack air is provided twice from the stationary valve to a rear end of a shuttle cylinder to urge the shuttle into the crack die of the nut cracking unit during a single rotation of the rotatable turret.

5. The nut cracking apparatus of claim 1, the rotatable turret defining a release air passage therethrough associated with each nut cracking unit from the rotatable valve plate to a forward end of the piston cylinder through which release air is communicated to urge the piston from an extended to a retracted position.

6. The nut cracking apparatus of claim 1, the shuttle movable into the crack die a first time during a rotation of the turret to crack a nut when the piston is in an extended position upon the application of air to the rear end of the shuttle cylinder and movable into the crack die a second time during the same rotation of the turret.

7. The nut cracking unit of claim 1, the rotatable turret comprising:
a piston cylinder body defining a plurality of piston cylinders;
a shuttle cylinder housing defining a plurality of shuttle cylinders; and
a shuttle in each shuttle cylinder movable from a rear end of the shuttle cylinder to a forward end to impact the crack die of the nut cracking unit, the piston cylinder body and shuttle cylinder body defining air passages therethrough that form at least a portion of the feed air passages associated with each nut cracking unit.

8. A nut cracking apparatus comprising:
a frame;
a piston cylinder body rotatably mounted in the frame, the piston cylinder body defining a plurality of piston cylinders with a piston movably disposed therein from a retracted position to an extended nut holding position;
a shuttle cylinder housing rotatable with the piston cylinder body, the shuttle cylinder housing defining a plurality of shuttle cylinders each with a shuttle movably disposed therein;
a crack die positioned at a forward end of each shuttle cylinder, the shuttle movable from a rear end to a forward end of the shuttle cylinder to impact the crack die; and
an air supply communicated with a rear end of the shuttle cylinder body, the air supply providing air to the rear end of the shuttle cylinder to move the shuttle in the shuttle cylinder twice to generate first and second impacts on the crack die during a single rotation of the shuttle cylinder body.

9. The nut cracking apparatus of claim 8, one of the first and second impacts occurring to crack a nut held between the piston and crack die when the piston is in the extended position, the other of the first and second impacts occurring after a nut has been cracked.

10. The nut cracking apparatus of claim 8, the shuttle cylinder housing and piston cylinder body each defining a plurality of feed air passages therethrough, each feed air passage in the shuttle cylinder housing communicated with a feed air passage in the piston cylinder body, each feed air passage in the piston cylinder body communicated with a rear end of a piston cylinder to communicate feed air thereto to move the piston to the extended position.

11. The nut cracking apparatus of claim 10, further comprising a center hub positioned between the shuttle cylinder housing and the piston cylinder body, the center hub having a plurality of feed air passages therethrough communicating the feed air passages in the shuttle cylinder body with the feed air passages in the piston cylinder body.

12. The nut cracking apparatus of claim 10, further comprising:
a valve plate connected to and rotatable with the shuttle cylinder body; and
a stationary valve positioned adjacent the valve plate, the feed air provided to the feed air passages in the shuttle cylinder body through the stationary valve and the valve plate.

13. The nut cracking apparatus of claim 10, further comprising a cylinder end plate connected to the piston cylinder housing and defining a plurality of ports therethrough communicating the feed air passages in the piston cylinder body with a rear end of the piston cylinders.

14. The nut cracking apparatus of claim 13, the cylinder end plate comprising first and second end plate sections removably connected to the piston cylinder housing.

15. A nut cracking apparatus comprising:
a frame;
a rotatable turret mounted to the frame;
a turret sprocket connected to the rotatable turret;
a drive sprocket connected to and rotated by a motor;
a chain engaging the drive sprocket and turret sprocket, the turret sprocket rotated by the motor, the rotating turret comprising:
a plurality of pistons movable in piston cylinders from a retracted position to an extended nut holding position;
a plurality of shuttles movable in shuttle cylinders from a rear end to a forward end thereof; and
a plurality of crack dies positioned at the forward end of the shuttle cylinders;
a rotatable valve plate positioned adjacent the rear end of the shuttle cylinders;
an air supply communicated with a stationary valve positioned adjacent the rotatable valve plate; and
the turret defining air passages for providing air communicated through the rotatable valve plate to the piston cylinders and shuttle cylinders to move the pistons and shuttles in their respective cylinders, the air passages being completely contained within the rotating turret.

16. The nut cracking apparatus of claim 15 comprising a plurality of nut cracking units, each nut cracking unit comprising one of the plurality of pistons, one of the plurality of crack dies and one of the plurality of shuttles, the valve plate defining a plurality of air ports communicable with each nut cracking unit to move the pistons and shuttles in the piston cylinders and shuttle cylinders.

17. The nut cracking apparatus of claim 16, the stationary valve defining first and second crack air openings, crack air being supplied to a rear end of each shuttle cylinder from the first and second crack openings through the rotatable valve plate during a single rotation of the valve plate to impact the crack die with the shuttle first and second times during the single rotation.

18. The nut cracking apparatus of claim 15, the rotatable turret comprising:
a piston cylinder body defining the piston cylinders, the piston cylinder body defining a feed air passage for communicating feed air to a rear end of each piston cylinder; and
a shuttle cylinder housing defining the shuttle cylinders, the shuttle cylinder housing defining a feed air passage for communicating air to the feed air passage in the piston cylinder body.

19. The nut cracking apparatus of claim 18, further comprising a center hub positioned between the piston cylinder body and the shuttle cylinder housing, the center hub having feed air passages communicating the feed air passages in the shuttle cylinder housing with the feed air passages in the piston cylinder body.

20. The nut cracking apparatus of claim 15 being less than 28″ wide, 22″ high and 41″ long and capable of cracking nuts at a rate in excess of 750 nuts/minute.

21. A nut cracking apparatus comprising:
a frame;
a rotatable turret mounted to the frame;
a plurality of nut cracking units in the rotatable turret, each nut cracking unit comprising:
a piston having a piston head and a piston rod extending therefrom movable in a piston cylinder from a retracted position to an extended position; and
a crack die aligned with the piston against which the piston secures a nut in its extended position;
a forward seal defining a frustoconical engagement surface positioned at a forward end of each of the piston cylinders; and
a rear seal defining a frustoconical engagement surface positioned at a rear end of each of the piston cylinders, the piston head comprising:
a generally cylindrical center portion sealingly engaged with the piston cylinder; and
a rear portion sloping radially inwardly in a rear direction from the center portion and defining a rear engagement surface for mating with the frustotoconical engagement surface on the rear seal.
